(19) United States
(12) Patent Application Publication
(10) Pub. No.: US 2005/0164063 A1
(43) Pub. Date: Jul. 28, 2005

(54) Compound, and solid electrolyte, proton conductor, membrane electrode assembly and fuel cell comprising the compound

(75) Inventors: Koji Wariishi, Haibara-gun (JP); Michio Ono, Fujinomiya-shi (JP); Kimiatsu Nomura, Minami-ashigara-shi (JP)

Correspondence Address: BRINKS HOFER GILSON & LIONE, P.O. BOX 10395, CHICAGO, IL, 60610, US

(73) Assignee: Fuji Photo Film Co., Ltd.

(21) Appl. No.: 10/969,530

(22) Filed: Oct. 20, 2004

(30) Foreign Application Priority Data
Oct. 20, 2003 (JP) 359927/2003
Feb. 2, 2004 (JP) 025055/2004

(51) Int. Cl. H01M 8/10; C07F 7/04

(52) U.S. Cl. 429/33; 556/482

(57) ABSTRACT

A solid electrolyte having a high ionic conductivity and not so much troubled by methanol-crossover through it is provided according to a method of sulfonation of a compound of the following formula (I), etc., followed by sol-gel reaction of the resulting compound, or according to a method of the sol-gel reaction followed by the sulfonation. 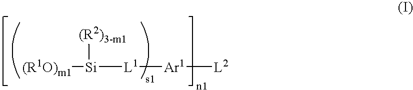
wherein R¹ represents a hydrogen atom, an alkyl group, an aryl group or a silyl group; R² represents an alkyl group, an aryl group or a heterocyclic group; m1 indicates an integer of from 1 to 3; L¹ represents a single bond, an alkylene group, —O—, —CO—, or a divalent linking group of a combination of any of these groups; L² represents an n1-valent linking group; Ar¹ represents an arylene or heteroarylene group having at least one electron-donating group; n1 indicates an integer of from 2 to 4; s1 indicates an integer of 1 or 2.

### BACKGROUND OF THE INVENTION

1. Field of the Invention

The present invention relates to a compound, and to a solid electrolyte, a proton conductor, a membrane electrode assembly and a fuel cell comprising the compound.

2. Description of the Related Art

These days it is expected that solid polymer fuel cells will be put into practical use for, for example, power sources for household use and power sources to be mounted on vehicles as clean power-generating devices that are ecological to the global environment. The main stream of such solid polymer fuel cells is toward those that require hydrogen and oxygen as the fuel thereof. Recently, a direct methanol fuel cell (DMFC) has been proposed, in which methanol is used in place of hydrogen for fuel. This is expected to give high-capacity batteries for mobile devices that are substitutable for lithium secondary batteries, and is now much studied in the art.

The important functions of the electrolytic membrane (solid electrolytic membrane) for solid polymer fuel cells are to physically insulate the fuel (e.g., hydrogen, aqueous methanol solution) fed to the anode, catalyst electrode from the oxidizing gas (e.g., oxygen) fed to the cathode, to electrically insulate the anode from the cathode, and to transmit the proton having been formed on the anode to the cathode. To fulfill these functions, the electrolytic membrane must have some mechanical strength and good proton conductivity.

In the solid electrolytic membrane, generally used is a sulfonic acid group-having perfluorocarbon polymer such as typically Nafion®. The solid electrolytic membrane of the type has good ionic conductivity and has relatively high mechanical strength, but has some problems to be solved such as those mentioned below. Concretely, in the solid electrolytic membrane, water and the sulfonic acid group form cluster channels, and protons move in the cluster channels via water therein. Therefore, the ionic conductivity of the membrane significantly depends on the water content thereof that is associated with the humidity in the service environment in which the cells are driven. For poisoning reduction in the catalyst electrode with CO and for activation of the catalyst electrode therein, solid polymer fuel cells are preferably driven at a temperature falling within a range of from 100 to 150° C. However, within such a middle-temperature range, the water content of the solid electrolytic membrane in the cells lowers with the reduction in the ionic conductivity thereof, and it causes a problem in that the expected cell characteristics could not be obtained. In addition, the softening point of the solid electrolytic membrane is around 120° C. and when the cells are driven at a temperature around it, then still another problem with it is that the mechanical strength of the solid electrolytic membrane is unsatisfactory. On the other hand, when the solid electrolytic membrane of the type is used in DMFC, then it causes still other problems such as those mentioned below. Naturally, the barrier ability of the membrane against the fuel methanol is not good as the membrane readily absorbs water, and therefore methanol having been fed to the anode penetrates through the solid electrolytic membrane to reach the cathode. Owing to it, the cell output power lowers, and this is referred to as a methanol-crossover phenomenon. For practical use of DMFC, this is one important problem to be solved.

Given that situation, there is a growing tendency for the development of other proton-conductive materials substitutable for Nafion®, and some hopeful solid electrolytic materials have been proposed. For example, for easy film formation based on the good characteristics of inorganic material, one proposal is a nanocomposite material hybridized with polymer material, as in JP-A 10-69817, 11-203936 and 2001-307752. For example, disclosed is a method of forming a proton conductor by hybridizing a polymer compound having a sulfonic acid group in the side branches, a silicon oxide and a proton acid. Another proposal is an organic-inorganic nanohybrid proton-conductive material that is obtained through sol-gel reaction of a precursor, organic silicon compound in the presence of a proton acid, as in Japanese Patent No. 3,103,888, German Patent DE 10061920A1,Electrochimica Acta, 1988, Vol. 43, Nos. 10-11, p. 1301, Industrial Material, by Nikkan Kogyo Shinbun, 2002, Vol. 50, p. 39, and Solid State Ionics, 2001, No. 145, p. 127. These organic-inorganic composite and hybrid proton-conductive materials comprise an inorganic component and an organic component, in which the inorganic component comprises silicic acid and proton acid and serves as a proton-conductive site and the organic component serves to make the materials flexible. When the inorganic component is increased so as to increase the proton conductivity of the membranes formed of the material, then the mechanical strength of the membranes lowers. On the other hand, however, when the organic component is increased so as to increase the flexibility of the membranes, then the proton conductivity of the membranes lowers. Therefore, the materials that satisfy the two characteristics are difficult to obtain. Regarding the methanol perviousness of the materials, which is an important characteristic of the materials for use in DMFC, satisfactory description is not found in the related literature.

### SUMMARY OF THE INVENTION

Objects of the present invention are to provide a compound for a solid electrolyte which has a high ionic conductivity and is not so much troubled by methanol-crossover through it and which is therefore favorable for DMFC, and to provide a solid electrolyte comprising the compound, a proton conductor and a membrane electrode assembly comprising the solid electrolyte, and a high-power fuel cell comprising the membrane electrode assembly. The term “solid electrolyte” as used herein may have the same meaning as that of “ion exchanger”. The term “solid electrolytic membrane” also used herein is meant to indicate a membrane-shaped solid electrolyte.

Taking the above-mentioned objects into consideration, we, the present inventors have assiduously studied and, as a result, have found that, when a sol-gel reaction precursor comprising an organosilicon compound is hybridized with a sol-gel reaction precursor in which the electron-donating group-having aryl group is sulfonated, then the organic molecular chain and the proton-donating group-bonded silicon-oxygen matrix moiety that is to be a proton-conductive channel undergo nano-level phase separation, and preferably the organic molecular chain is oriented horizontally to the membrane face, and, as a result, an organic-inorganic nano-hybrid material may be constructed in which the proton-conductive channel runs to cross the membrane face. In addition, we have further found that the membrane thus obtained is flexible and has high mechanical strength. On the basis of these findings, we have reached the present invention. In particular, an organic-inorganic hybrid solid electrolyte that is obtained through sol-gel reaction of a solution of a sulfonic acid compound obtained through sulfonation of at least one compound of general formulae (I), (III) and (IV) combined with at least any one organosilicon compound of general formulae (VII) and/or (VIII) is especially favorable for the objects of the invention. Through observation thereof with a polarizing microscope, we have clarified that the solid electrolyte of the type forms aggregates of oriented organic molecular chains therein. In this case, the proton-donating group-bonded silicon-oxygen network that is to be a proton-conductive channel is formed inevitably in the direction perpendicular to the orientation direction of the organic molecule aggregates. Accordingly, when the orientation direction of the organic molecular chains is controlled to the horizontal direction relative to the membrane face, then the proton-conductive channels are constructed to cross the membrane.

Concretely, the objects of the invention can be attained by the following constitution:

1. A compound obtained according to a method comprising sulfonation of at least one compound of the following general formulae (I), (III) and (IV) followed by sol-gel reaction of the resulting compound, or according to a method comprising the sol-gel reaction followed by the sulfonation: 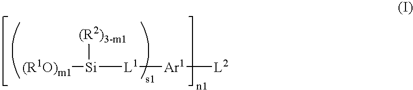
wherein R¹ represents a hydrogen atom, an alkyl group, an aryl group or a silyl group; R² represents an alkyl group, an aryl group or a heterocyclic group; m1 indicates an integer of from 1 to 3; L¹ represents a single bond, an alkylene group, —O—, —CO—, or a divalent linking group of a combination of any of these groups; L2 represents an n1-valent linking group; Ar¹ represents an arylene or heteroarylene group having at least one electron-donating group; n1 indicates an integer of from 2 to 4; s1 indicates an integer of 1 or 2; 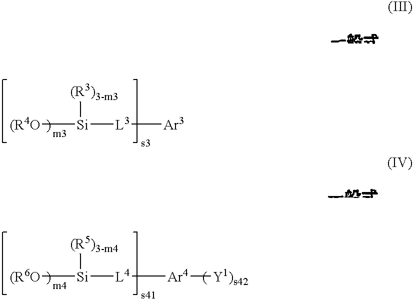
wherein R³ and R⁵ each represent an alkyl group, an aryl group or a heterocyclic group; R⁴ and R⁶ each represent a hydrogen atom, an alkyl group, an aryl group or a silyl group; m3 and m4 each indicate an integer of from 1 to 3; L³ and L⁴ each represent a single bond or a divalent linking group; Ar³ and Ar⁴ each represent an aryl or heteroaryl group or an arylene or heteroarylene group having at least one electron-donating group; s3, s41 and s42 each indicate an integer of from 1 to 4; Y¹ represents a polymerizing group capable of forming a carbon-carbon bond or a carbon-oxygen bond through polymerization.

2. The compound of above 1, wherein at least one compound of formulae (I), (III) and (IV) is a compound of formula (I).

3. The compound of above 1, wherein at least one compound of formulae (I), (III) and (IV) is at least one compound of formulae (III) and (IV).

4. The compound of above 1, wherein at least one compound of formulae (I), (III) and (IV) is a compound of formula (I), and the compound of formula (I) contains n1 and the same partial structures of the following general formula (V): 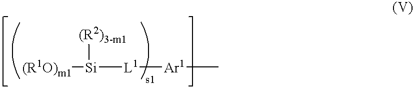
wherein R¹, R², m1, L¹, s1 and Ar¹ have the same meanings as those of R¹, R¹, m1, L¹, s1 and Ar¹ in formula (I).

5. The compound of above 1, wherein at least one compound of formulae (I), (III) and (IV) is a compound of formula (I), and the compound of formula (I) is a compound of the following general formula (VI): 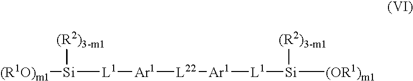
wherein R¹, R², m1, L¹ and Ar¹ have the same meanings as those of R¹, R², m1, L¹ and Ar¹ in formula (I); and L²² represents a divalent linking group.

6. The compound of above 1, wherein the electron-donating group is a hydroxyl group or an alkoxy group.

7. The compound of above 1, wherein the electron-donating group is a hydroxyl group.

8. The compound of above 1, wherein at least one organosilicon compound having a mesogen-containing group is added to the sol-gel reaction.

9. The compound of above 1, wherein at least one compound of the following general formulae (VII) and (VIII) is added to the sol-gel reaction: 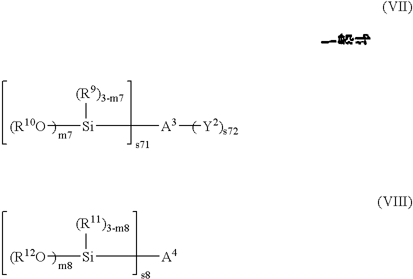
wherein A³ and A⁴ each represent a mesogen-containing organic atomic group; R⁹ and R¹¹ each represent an alkyl group, an aryl group or a heterocyclic group; R¹⁰ and R¹² each represent a hydrogen atom, an alkyl group, an aryl group or a silyl group; Y² represents a polymerizing group capable of forming a carbon-carbon bond or a carbon-oxygen bond through polymerization; m7 and m8 each indicate an integer of from 1 to 3; s71 and s8 each indicate an integer of from 1 to 8; s72 indicates an integer of from 1 to 4.

10. A solid electrolyte containing the compound of above 1.

11. A proton conductor containing the compound of above 1.

12. A membrane electrode assembly that contains a solid electrolytic membrane containing the compound of above 1, between an anode and a cathode.

13. A membrane electrode assembly that contains a solid electrolytic membrane containing the compound of above 1, in an anode and a cathode.

14. A fuel cell that contains a membrane electrode assembly with a solid electrolytic membrane containing the compound of above 1, between an anode and a cathode.

15. A method for producing a solid electrolyte, which comprises sulfonation of at least one compound of the following general formula (I), (III) and (IV) followed by sol-gel reaction of the resulting compound, or comprises the sol-gel reaction followed by the sulfonation: 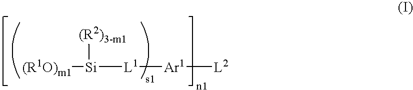
wherein R¹ represents a hydrogen atom, an alkyl group, an aryl group or a silyl group; R² represents an alkyl group, an aryl group or a heterocyclic group; m1 indicates an integer of from 1 to 3; L¹ represents a single bond, an alkylene group, —O—, —CO—, or a divalent linking group of a combination of any of these groups; L² represents an n1-valent linking group; Ar¹ represents an arylene or heteroarylene group having at least one electron-donating group; n1 indicates an integer of from 2 to 4; s1 indicates an integer of 1 or 2; 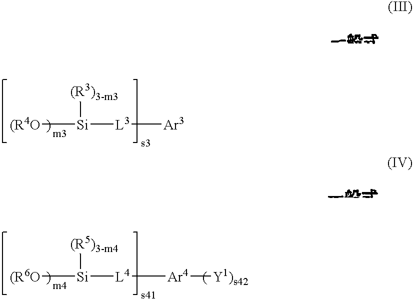
wherein R³ and R⁵ each represent an alkyl group, an aryl group or a heterocyclic group; R⁴ and R⁶ each represent a hydrogen atom, an alkyl group, an aryl group or a silyl group; m3 and m4 each indicate an integer of from 1 to 3; L³ and L⁴each represent a single bond or a divalent linking group; Ar³ and Ar⁴ each represent an aryl or heteroaryl group or an arylene or heteroarylene group having at least one electron-donating group; s3, s41 and s42 each indicate an integer of from 1 to 4; Y¹ represents a polymerizing group capable of forming a carbon-carbon bond or a carbon-oxygen bond through polymerization.

16. The method for producing a solid electrolyte of above 15, wherein the sulfonation is effected with SO₃ or an SO₃-organic complex.

17. The method for producing a solid electrolyte of above 15, wherein the sulfonation temperature falls between 20° C. and 100° C.

18. The method for producing a solid electrolyte of above 15, wherein the compound of formula (I) contains n1 and the same partial structures of the following general formula (V) 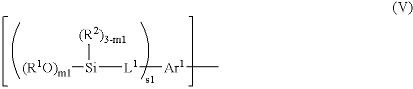
wherein R¹, R², m1, L¹, s1 and Ar¹ have the same meanings as those of R¹, R², m1, L¹, s1 and Ar¹ in formula (I).

19. The method for producing a solid electrolyte of above 15, wherein the compound of formula (I) is a compound of the following general formula (VI): 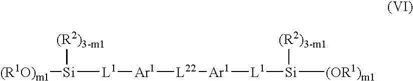
wherein R¹, R², m1, L¹ and Ar¹ have the same meanings as those of R¹, R², m1, L¹ and Ar¹ in formula (I); and L²² represents a divalent linking group.

20. The method for producing a solid electrolyte of above 15, wherein the electron-donating group is a hydroxyl group or an alkoxy group.

21. The method for producing a solid electrolyte of above 15, wherein the electron-donating group is a hydroxyl group.

22. The method for producing a solid electrolyte of above 15, wherein at least one organosilicon compound having a mesogen-containing group is added to the sol-gel reaction.

23. The method for producing a solid electrolyte of above 15, wherein at least one compound of the following general formulae (VII) and (VIII) is added to the sol-gel reaction: 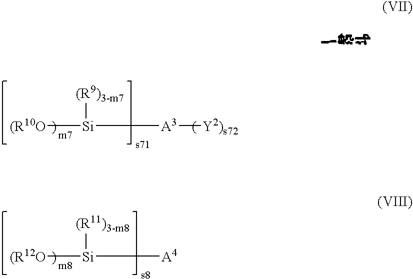
wherein A³ and A⁴ each represent a mesogen-containing organic atomic group; R⁹ and R¹¹ each represent an alkyl group, an aryl group or a heterocyclic group; R¹⁰ and R¹² each represent a hydrogen atom, an alkyl group, an aryl group or a silyl group; Y² represents a polymerizing group capable of forming a carbon-carbon bond or a carbon-oxygen bond through polymerization; m7 and m8 each indicate an integer of from 1 to 3; s71 and s8 each indicate an integer of from 1 to 8; s72 indicates an integer of from 1 to 4.

### BRIEF DESCRIPTION OF THE DRAWINGS

FIG. 1 is a schematic cross-sectional view showing the constitution of a membrane electrode assembly that comprises the solid electrolytic membrane of the invention.

FIG. 2 is a schematic cross-sectional view showing one example of the constitution of the fuel cell of the invention.

FIG. 3 is a schematic view showing a stainless steel cell of the invention employed in determination of methanol perviousness through the membrane therein.

### BEST MODE FOR CARRYING OUT THE INVENTION

The invention is described in detail hereinunder. In this description, the numerical range expressed by the wording “a number to another number” means the range that falls between the former number indicating the lowermost limit of the range and the latter number indicating the uppermost limit thereof.

[1] Organosilicon Compound and Sulfonic Acid Group-Containing Precursor:

The solid electrolyte of the invention has a structure of an aryl group that contains an electron-donating group, preferably a hydroxyl group or an alkoxy group, more preferably a hydroxyl group, and a sulfo group both covalent-bonding to a silicon-oxygen three-dimensional crosslinked matrix therein. The solid electrolyte may be formed through sol-gel reaction of at least one precursor, organosilicon compound of formulae (I), (III) and (IV). The precursor for forming it is described in detail hereinunder.

[1-1] Organosilicon Compound Precursor:

The solid electrolyte of the invention may be formed through sol-gel reaction of at least one precursor, organosilicon compound of formulae (I), (III) and (IV).

In the organosilicon compound of formula (I), R² represents an alkyl group, an aryl group or a heterocyclic group, R¹ represents a hydrogen atom, an alkyl group, an aryl group or a silyl group. Preferred examples of the alkyl group for R¹ and R² are linear, branched or cyclic alkyl groups (e.g., those having from 1 to 20 carbon atoms, such as methyl, ethyl, isopropyl, n-butyl, 2-ethylhexyl, n-decyl, cyclopropyl, cyclohexyl, cyclododecyl). Preferred examples of the aryl group for R¹ and R² are substituted or unsubstituted phenyl or naphthyl groups having from 6 to 20 carbon atoms. Preferred examples of the heterocyclic group for R² are substituted or unsubstituted 6-membered heterocyclic groups (e.g., pyridyl, morpholino), and substituted or unsubstituted 5-membered heterocyclic groups (e.g., furyl, thiophenyl). Preferred examples of the silyl group for R¹ are silyl groups substituted with three alkyl groups selected from alkyl groups having from 1 to 10 carbon atoms (e.g., trimethylsilyl, triethylsilyl, triisopropylsilyl), and polysiloxane groups (e.g., -(Me₂SiO)ₙH where n=10 to 100). m1 is preferably 2 or 3, more preferably 3.

L¹ represents a single bond, an alkylene group, —O—, —CO—, or a divalent linking group of a combination of any of these groups. Preferably, it is an alkylene group, more preferably an alkylene group having from 2 to 20 carbon atoms. The single bond is meant to indicate that Si directly bonds to Ar¹.

L² represents an n1-valent linking group. Examples of the n1-valent linking group are an alkylene group, an alkenylene group, an arylene group, —O—, —S—, —CO—, —NR′— (where R′ represents a hydrogen atom or an alkyl group), and a linking group of a combination of at least two of these (more preferably, a divalent linking group). The linking group is preferably a combination of an alkylene group and —O—, or the combination further combined with at least one of an alkylene group, an arylene group or —CO— (even more preferably, a divalent linking group) The alkylene group preferably has from 2 to 20 carbon atoms.

n1 is an integer of from 2 to 4, preferably 2 or 4, more preferably 2. When n1 is 2 or more, then the corresponding R¹'s, R²'s, L¹'s, Ar¹'s, m1's and s1's may be the same or different, but are preferably the same. s1 is an integer of 1 or 2, preferably 1. When s1 is 2, then the corresponding R¹'s, R²'s, L¹'s and m1's may be the same or different, but are preferably the same.

Ar¹ represents an arylene or heteroarylene group (hereinafter this is referred to as (hetero)arylene group) having at least one electron-donating group. The electron-donating group is preferably a substituent having a Hammett's σp value of at most −0.15. The Hammett's σp value is described in Chemical Review, Vol. 91, No. 2 (1991), pp. 165-195. For example, the substituent includes a methyl group (−0.17), a methoxy group (−0.27), a hydroxyl group (−0.37), a dimethylamino group (−0.83). Of those, preferred are a hydroxyl group and an alkoxy group (more preferably, methoxy or ethoxy). Even more preferred is a hydroxyl group. The electron-donating group may be in any position in Ar¹, but is preferably so positioned that the ortho or para-position is unsubstituted. The (hetero)arylene group may have any other substituent than the electron-donating group, still having a position at which the group is sulfonated. For example, the group may be substituted with any of the substituents T mentioned below.

In addition, the (hetero)arylene group may be condensed. In this case, it preferably forms a bicyclic group. The arylene or heteroarylene group having at least one electron-donating group is, for example, a (hetero)arylene group having from 6 to 24 carbon atoms, more concretely including a hydroxyphenylene group, a hydroxynaphthylene group, a methoxyfurandiyl group, a methoxythiophene-diyl group, and a hydroxypyridine-diyl group.

(Substituents T)

1. Alkyl Group:

The alkyl group may be optionally substituted, and is more preferably an alkyl group having from 1 to 24 carbon atoms, even more preferably from 1 to 10 carbon atoms. It may be linear or branched. For example, it includes methyl, ethyl, propyl, butyl, i-propyl, i-butyl, pentyl, hexyl, octyl, 2-ethylhexyl, t-octyl, decyl, dodecyl, tetradecyl, 2-hexyldecyl, hexadecyl, octadecyl, cyclohexylmethyl and octylcyclohexyl groups.

2. Aryl Group:

The aryl group may be optionally substituted and condensed, and is more preferably an aryl group having from 6 to 24 carbon atoms. For example, it includes phenyl, 4-methylphenyl, 3-cyanophenyl, 2-chlorophenyl and 2-naphthyl groups.

3. Heterocyclic Group:

The heterocyclic group may be optionally substituted and condensed. When it is a nitrogen-containing heterocyclic group, the nitrogen atom in the ring thereof may be optionally quaternated. More preferably, the heterocyclic group has from 2 to 24 carbon atoms. For example, it includes 4-pyridyl, 2-pyridyl, 1-octylpyridinium-4-yl, 2-pyrimidyl, 2-imidazolyl and 2-thiazolyl groups.

4. Alkoxy Group:

More preferably, the alkoxy group has from 1 to 24 carbon atoms. For example, it includes methoxy, ethoxy, butoxy, octyloxy, methoxyethoxy, methoxypenta(ethyloxy), acryloyloxyethoxy and pentafluoropropoxy groups.

5. Acyloxy Group:

More preferably, the acyloxy group has from 1 to 24 carbon atoms. For example, it includes acetyloxy and benzoyloxy groups.

6. Alkoxycarbonyl Group:

More preferably, the alkoxycarbonyl group has from 2 to 24 carbon atoms. For example, it includes methoxycarbonyl and ethoxycarbonyl groups.

7. Carbamoyloxy Group, Alkoxycarbonyloxy Group:

For example, these includes N,N-dimethylcarbamoyloxy, N,N-diethylcarbamoyloxy, morpholinocarbonyloxy, N,N-di-n-octylaminocarbonyloxy, N-n-octylcarbamoyloxy, methoxycarbonyloxy, ethoxycarbonyloxy, t-butoxycarbonyloxy and n-octylcarbonyloxy groups.

8. Aryloxycarbonyloxy Group:

For example, this includes phenoxycarbonyloxy, p-methoxyphenoxycarbonyloxy and p-n-hexadecyloxyphenoxycarbonyloxy groups.

9. Amino Group:

For example, this includes amino, methylamino, dimethylamino, anilino, N-methyl-anilino and diphenylamino groups.

10. Acylamino Group:

For example, this includes formylamino, acetylamino, pivaloylamino, lauroylamino, benzoylamino and 3,4,5-tri-n-octyloxyphenylcarbonylamino groups.

11. Aminocarbonylamino Group:

For example, this includes carbamoylamino, N,N-dimethylaminocarbonylamino, N,N-diethylaminocarbonylamino and morpholinocarbonylamino groups.

12. Alkoxycarbonylamino Group:

For example, this includes methoxycarbonylamino, ethoxycarbonylamino, t-butoxycarbonylamino, n-octadecyloxycarbonylamino and N-methyl-methoxycarbonylamino groups.

13. Aryloxycarbonylamino Group:

For example, this includes phenoxycarbonylamino, p-chlorophenoxycarbonylamino and m-n-octyloxyphenoxycarbonylamino groups.

14. Sulfamoylamino Group:

For example, this includes sulfamoylamino, N,N-dimethylaminosulfonylamino and N-n-octylaminosulfonylamino groups.

15. Alkyl and Arylsulfonylamino Groups:

For example, these include methylsulfonylamino, butylsulfonylamino, phenylsulfonylamino, 2,3,5-trichlorophenylsulfonylamino and p-methylphenylsulfonylamino groups.

16. Sulfamoyl Group:

For example, this includes N-ethylsulfamoyl, N-(3-dodecyloxypropyl)sulfamoyl, N,N-dimethylsulfamoyl, N-acetylsulfamoyl, N-benzoylsulfamoyl and N-(N′-phenylcarbamoyl)sulfamoyl groups.

17. Alkyl and Arylsulfinyl Groups:

For example, these include methylsulfinyl, ethylsulfinyl, phenylsulfinyl and p-methylphenylsulfinyl groups.

18. Alkyl and Arylsulfonyl Groups:

For example, these include methylsulfonyl, ethylsulfonyl, phenylsulfonyl and p-methylphenylsulfonyl groups.

19. Acyl Group:

For example, this includes acetyl, pivaloyl, 2-chloroacetyl, stearoyl, benzoyl and p-n-octyloxyphenylcarbonyl groups.

20. Aryloxycarbonyl Group:

For example, this includes phenoxycarbonyl, o-chlorophenoxycarbonyl, m-nitrophenoxycarbonyl and p-t-butylphenoxycarbonyl groups.

21. Carbamoyl Group:

For example, this includes carbamoyl, N-methylcarbamoyl, N,N-dimethylcarbamoyl, N,N-di-n-octylcarbamoyl and N-(methylsulfonyl)carbamoyl groups.

22. Silyl Group:

Preferably, this has from 3 to 30 carbon atoms, including, for example, trimethylsilyl, t-butyldimethylsilyl, phenyldimethylsilyl, trimethoxysilyl, triethoxysilyl, dimethoxymethylsilyl, diethoxymethylsilyl and triacetoxysilyl groups.

23. Cyano Group.

24. Fluoro Group.

25. Mercapto Group.

26. Hydroxyl group.

More preferably, the n1's partial structures of formula (V) to constitute the compound of formula (1) are the same. In formula (V), R¹R², m1, L¹, s1 and Ar¹ have the same meanings as those of R¹, R², m1, L¹, s1 and Ar¹ in formula (I), and their preferred ranges are also the same as those of the latter.

More preferably, the compound of formula (I) is a compound of the following general formula (VI): 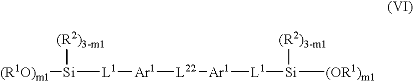
wherein R¹, R², m1, L¹ and Ar¹ have the same meanings as those of R¹, R², m1, L¹ and Ar¹ in formula (I); and L²² represents a divalent linking group.

Examples of L²² are an alkylene group, an alkenylene group, an arylene group, —O—, —S—, —CO—, —NR′— (where R′ is a hydrogen atom or an alkyl group), and a divalent group of a combination of at least two of these. The linking group is preferably a divalent linking group of a combination of an alkylene group and —O—, or the combination further combined with at least one of an alkylene group, an arylene group or —CO—. The alkylene group preferably has from 2 to 20 carbon atoms.

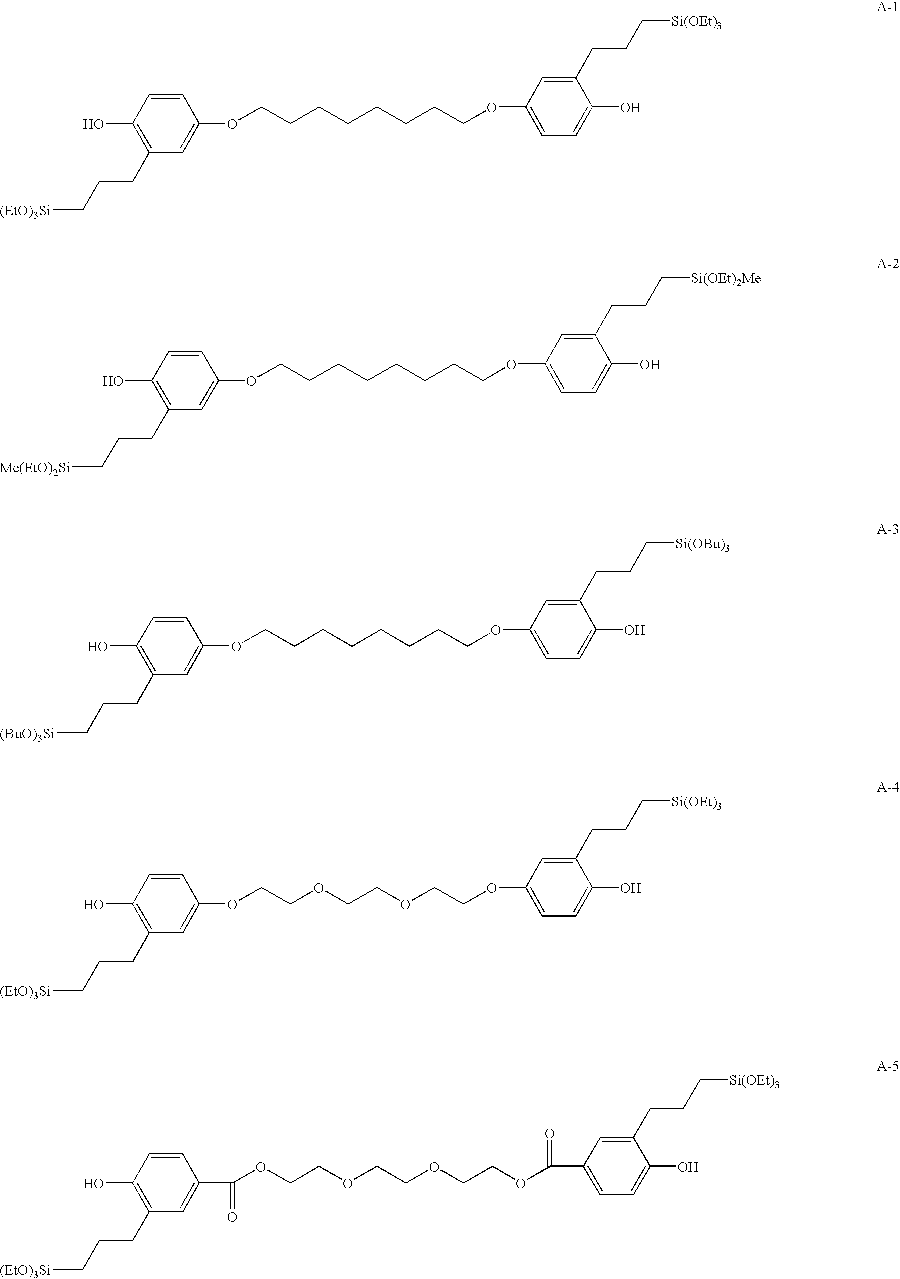

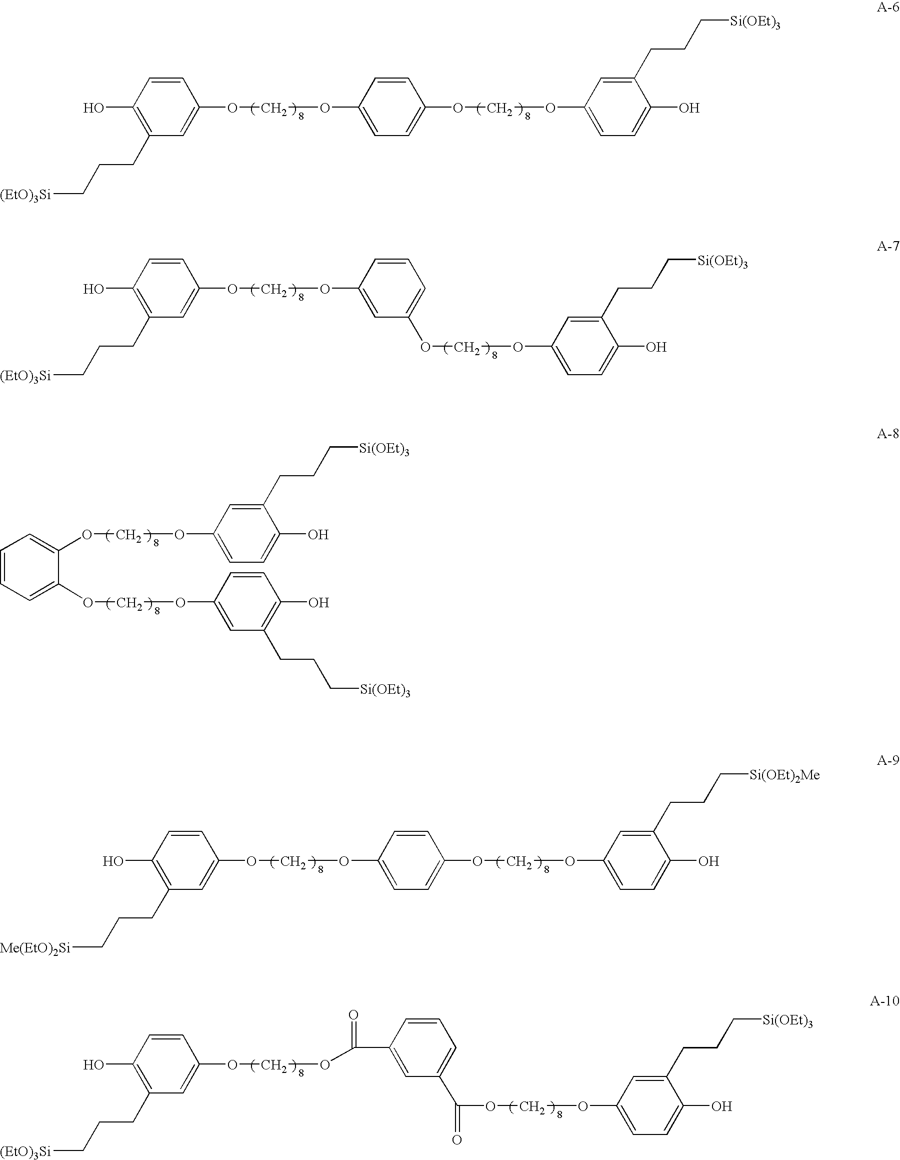

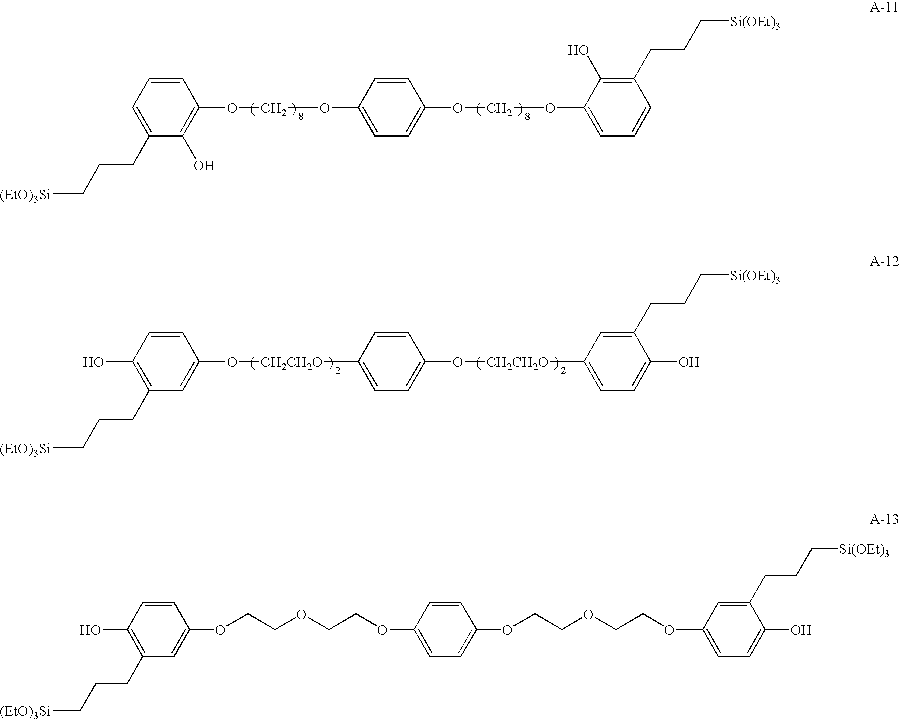

In the organosilicon compound of formulae (III) and/or (IV), R³ and R⁵ each represent an alkyl group, an aryl group or a heterocyclic group; R⁴ and R⁶ each represent a hydrogen atom, an alkyl group, an aryl group or a silyl group. Preferred examples of the alkyl group for R³ to R⁶ are linear, branched or cyclic alkyl groups (e.g., those having from 1 to 20 carbon atoms, such as methyl, ethyl, isopropyl, n-butyl, 2-ethylhexyl, n-decyl, cyclopropyl, cyclohexyl, cyclododecyl). Preferred examples of the aryl group for R³ to R⁶ are substituted or unsubstituted phenyl or naphthyl groups having from 6 to 20 carbon atoms. Preferred examples of the heterocyclic group for R³ and R⁵ are substituted or unsubstituted 6-membered heterocyclic groups (e.g., pyridyl, morpholino), and substituted or unsubstituted 5-membered heterocyclic groups (e.g., furyl, thiophenyl). Preferred examples of the silyl group for R⁴ and R⁶ are silyl groups substituted with three alkyl groups selected from alkyl groups having from 1 to 10 carbon atoms (e.g., trimethylsilyl, triethylsilyl, triisopropylsilyl), and polysiloxane groups (e.g., -(Me₂SiO)ₙH where n=10 to 100). Preferably, m3 and m4 each are 2 or 3, more preferably 3. When m3, (3-m3), m4 or (3-m4) is 2 or more, then the corresponding R³'s to R⁶'s may be the same or different.

L³ and L⁴ each represent a single bond or a divalent linking group. Examples of the divalent linking group are an alkylene group, an alkenylene group, an arylene group, —O—, —S—, —CO—, —NR′— (where R′ is a hydrogen atom or an alkyl group), —SO₂—, and a divalent linking group of a combination of at least two of these. Of the linking groups mentioned above, preferred are a single bond, an alkylene group, a combination of an alkylene group and —O—, and a combination of an alkylene group, —CO— and —O—. The alkylene group preferably has from 2 to 6 carbon atoms. The single bond is meant to indicate that Si directly bonds to Ar³ or to Ar⁴.

Ar³ represents an aryl or heteroaryl group (hereinafter this is referred to as (hetero)aryl group) substituted with at least one electron-donating group. The electron-donating group is preferably a substituent having a Hammett's σp value of at most −0.15. TheHammett's σp value is described in Chemical Review, Vol. 91, No. 2 (1991), pp. 165-195. For example, the substituent includes a methyl group (−0.17), a methoxy group (−0.27), a hydroxyl group (−0.37), a dimethylamino group (−0.83) Especially preferably, it is a hydroxyl group. Regarding the position at which the electron-donating group may be substituted, the group may be in any of ortho-, meta- or para-position to (R⁴O)ₘ₃—Si(R³)₃₋ₘ₃-L³- when the number of the electron-donating group is one, but is preferably in the ortho- or para-position, more preferably in the ortho-position. When the number of the electron-donating groups is 2 or more, then the groups may be in any positions. The (hetero)aryl group may have any other substituent than the electron-donating group. The position of the additional substituent is not also specifically defined. In addition, the (hetero)aryl group may be condensed. In this case, it preferably forms a bicyclic group. The aryl group substituted with at least one electron-donating group for Ar³ is preferably a (hetero)aryl group having from 6 to 24 carbon atoms. For example, it includes a hydroxyphenyl group, a hydroxynaphthyl group, a hydroxybiphenyl group, a methoxyfuryl group, a methoxythienyl group, and a hydroxypyridyl group.

Ar⁴ represents an arylene or heteroarylene group (hereinafter this is referred to as (hetero)arylene group) substituted with at least one electron-donating group. The electron-donating group in this may be the same as that to be in Ar³, and its preferred range may also be the same as that for the latter. Regarding the position at which the electron-donating group may be substituted, the group may be in any of ortho-, meta- or para-position to (R⁶O)ₘ₄—Si(R⁵)₃₋ₘ₄-L⁴- or to Y¹—, when Ar⁴ is a 6-membered group and when the number of the electron-donating group is one, but is preferably in the ortho- or para-position, more preferably in the ortho-position. When the number of the electron-donating groups is 2 or more, then the groups may be in any positions. When Ar⁴ is a 5-membered group, then the electron-donating groups may be in any positions to (R⁶O)ₘ₄—Si(R⁵)₃₋ₘ₄-L⁴— or to Y¹—, but are preferably on the neighboring carbon atoms. The (hetero)arylene group may have any other substituent than the electron-donating group. The position of the additional substituent is not also specifically defined. In addition, the (hetero)arylene group may be condensed. In this case, it preferably forms a bicyclic group. The arylene group substituted with at least one electron-donating group for Ar⁴ is preferably a (hetero)arylene group having from 6 to 24 carbon atoms. For example, it includes a hydroxyphenylene group, a hydroxynaphthylene group, a hydroxybiphenylene group, a methoxyfuran-diyl group, a methoxythiophene-diyl group, a hydroxypyridine-diyl group. Preferred examples of the substituents for the group may be the same as those mentioned hereinabove for formula (I).

s3, s41 and s42 each indicate an integer of from 1 to 4, preferably from 1 to 3. When s3, s41 and s42 are 2 or more, then the corresponding R³'s to R⁶'s, m3's, m4's, L³'s, L⁴'s and Y¹'s may be the same or different.

Y¹ represents a polymerizing group capable of forming a carbon-carbon bond or a carbon-oxygen bond through polymerization. For example, it includes an acryloyl group, a methacryloyl group, a vinyl group, an ethynyl group, an alkyleneoxide group (e.g., ethyleneoxide, trimethyleneoxide). Above all, preferred are an acryloyl group, amethacryloyl group, an ethyleneoxide group, a trimethyleneoxide group; and more preferred are an ethyleneoxide group and a trimethyleneoxide group.

Y¹ may directly bond to Ar⁴, or may bond thereto via a substituent on Ar⁴.

Specific examples of the organosilicon compounds of formulae (III) and (IV) are mentioned below, to which, however, the invention should not be limited. 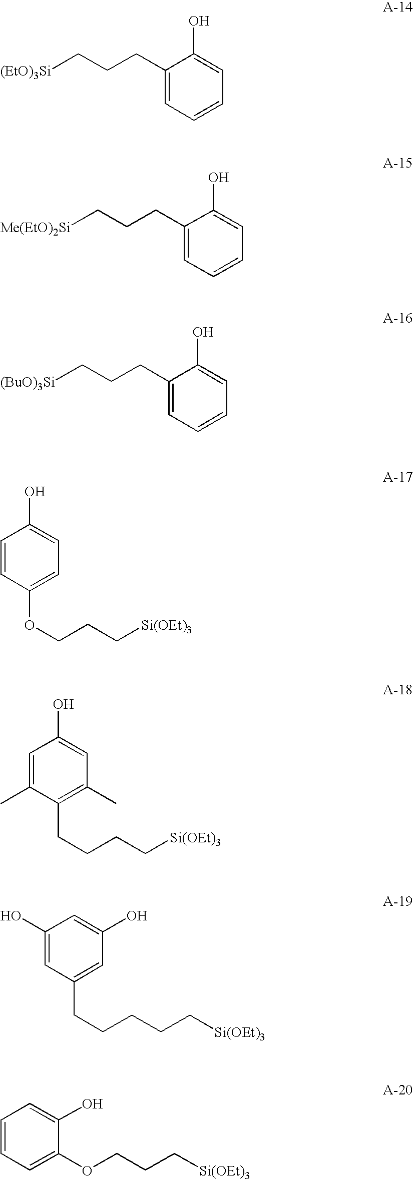 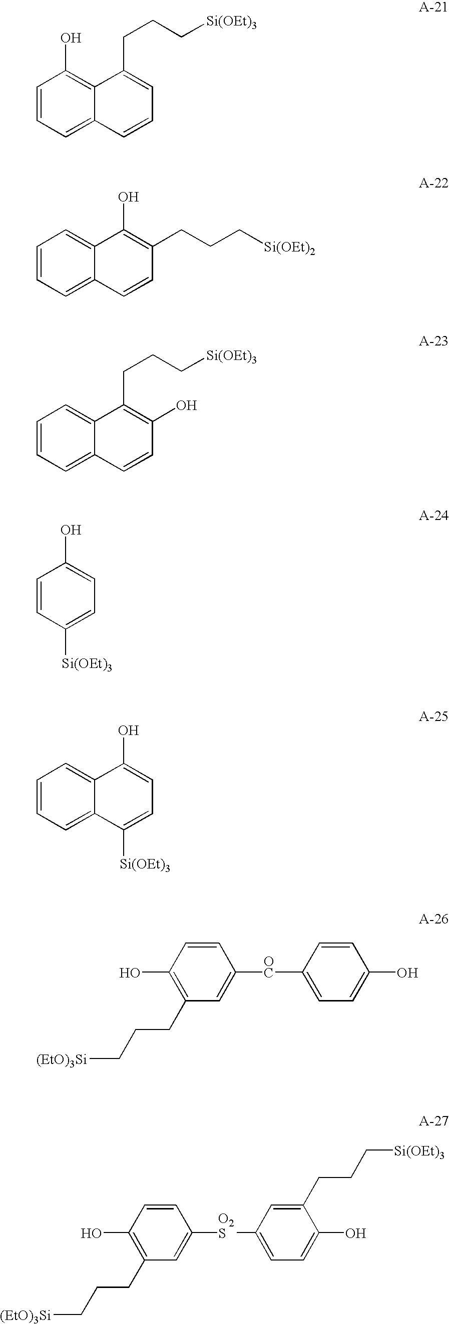 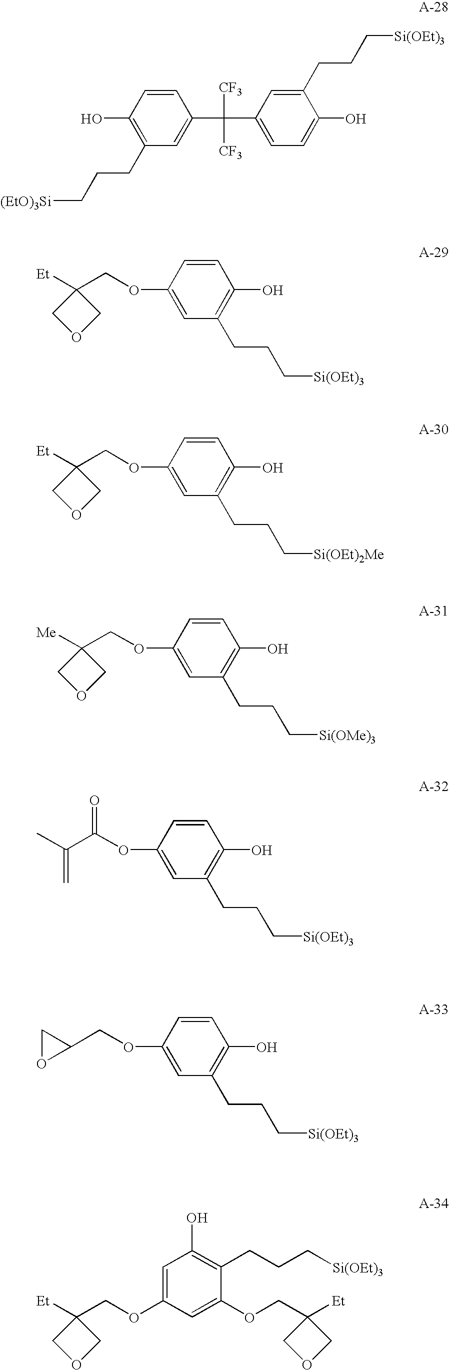
[1-2] Introduction of Sulfo Group:

Preferably, a sulfo group is introduced into the solid electrolytic membrane of the invention, for which at least one organosilicon compound of formulae (I), (III) and (IV) is reacted with a sulfonating reagent before or after the sol-gel reaction to be mentioned below, or after the film formation.

The sulfonating reagent acts on the (hetero)arylene group in formula (I), (III) or (IV), directly or via the substituent of the group, and a sulfo group is thereby introduced into the compound.

For the sulfonating reagent, for example, herein usable are those described in New Experimental Chemistry Lecture, Vol. 14, 3rd. Ed., Synthesis and Reaction of Organic Compound (edited by the Chemical Society of Japan). Preferred example of the sulfonating reagent for use herein are sulfuric acid, chlorosulfonic acid, fuming sulfuric acid, amidosulfuric acid, sulfur trioxide, sulfur trioxide complexes (e.g., SO₃-DMF, SO₃-THF, SO₃-dioxane, SO₃-pyridine). More preferred examples are chlorosulfonic acid and sulfur trioxide complexes; and even more preferred are sulfur trioxide complexes.

Preferably, the solvent for the sulfonation is the same as that to be used in the sol-gel reaction to be mentioned hereinunder. The overall solvent amount to be used is preferably from 0.1 to 100 g, more preferably from 1 to 10 g per gram of the precursor compound. The reaction temperature is associated with the reaction speed, and it may be determined depending on the reactivity of the precursor and the type and the amount of the selected sulfonating reagent. Preferably, it falls between −20° C. and 150° C., more preferably between 0° C. and 120° C., even more preferably between 20° C. and 100° C. The amount of the sulfonating reagent to be used is preferably from 1 to 10 times by mol, more preferably from 2 to 5 times by mol, relative to the molar number of the Ar¹ units in the compound of formula (I), the Ar³ units in the compound of formula (III) or the Ar⁴ units in the compound of formula (IV). Preferably, the solvent for the sulfonation is dewatered into an almost anhydrous one in order to prevent the sulfonating reagent from being decomposed.

[1-3] Mesogen-Containing Organosilicon Compound:

Preferably, at least one silicon compound having a mesogen-containing group is added to the sol-gel reaction in the invention. Also preferably, the silicon compound that has a mesogen-containing group is at least one compound of formulae (VII) and (VIII).

In the mesogen-containing organosilicon compound of formulae (VII) and (VIII), R⁹ and R¹¹ each represent an alkyl group, an aryl group or a heterocyclic group; and R¹⁰ and R¹² each represent a hydrogen atom, an alkyl group, an aryl group or a silyl group. Preferred examples of the alkyl group for R⁹ to R¹² are linear, branched or cyclic alkyl groups (e.g., those having from 1 to 20 carbon atoms, such as methyl, ethyl, isopropyl, n-butyl, 2-ethylhexyl, n-decyl, cyclopropyl, cyclohexyl, cyclododecyl); preferred examples of the aryl group for R⁹ to R¹² are substituted or unsubstituted phenyl or naphthyl groups having from 6 to 20 carbon atoms. Preferred examples of the heterocyclic group for R⁹ and R¹¹ are substituted or unsubstituted 6-membered heterocyclic groups (e.g., pyridyl, morpholino), and substituted or unsubstituted 5-membered heterocyclic groups (e.g., furyl, thiophenyl). Preferred examples of the silyl group for R¹⁰ and R¹² are silyl groups substituted with three alkyl groups selected from alkyl groups having from 1 to 10 carbon atoms (e.g., trimethylsilyl, triethylsilyl, triisopropylsilyl), and polysiloxane groups (e.g., -(Me₂SiO)ₙH where n=10 to 100). Preferably, m7 and/or m8 each are 2 or 3, more preferably 3. When m7, m8, (3-m7), (3-m8), s71, s72 or s8 is 2 or more, then the corresponding R⁹'s to R¹²'s, m7's, m8's, and Y²'s may be the same or different.

s71 is an integer of from 1 to 8, preferably from 1 to 4, more preferably 1 or 2. s72 is an integer of from 1 to 4, preferably 1 or 2, more preferably 1. s8 is an integer of from 1 to 8, preferably from 1 to 4, more preferably 1 or 2.

A³ and A⁴ each represent a mesogen-containing organic atomic group. Preferred examples of the mesogen group are described in Dietrich Demus & Horst Zaschke, Flussige Kristalle in Tablelen II, 1984, pp. 7-18. Those of the following general formula (IX) are especially preferred:

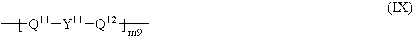

In formula (IX), Q¹¹ and Q¹² each represent a divalent linking group or a single bond. The divalent linking group is preferably —CH═CH—, —CH═N—, —N═N—, —N(O)═N—, —COO—, —COS—, —CONH—, —COCH₂—, —CH₂CH₂—, —OCH₂—, —CH₂NH—, —CH₂—, —CO—, —O—, —S—, —NH—, —(CH₂)_{(1 to 3)}—, —CH═CH—COO—, —CH═CH—CO—, —(C≡C)_{(1 to 3)}—, or their combination, more preferably —CH₂—, —CO—, —O—, —CH═CH—, —CH═N—, —N═N—, or their combination. The hydrogen atom of these divalent linking groups may be substituted with any other substituent. Preferably, Q¹¹ and Q¹² are any one or a combination of —CH═CH—, —(CH₂)_{(1 to 3)}— and —O—, or a single bond; more preferably, —[—O—(CH₂)ₘ₁₁]ₘ₁₀— (where m11 indicates an integer of from 1 to 24, preferably from 2 to 16, more preferably from 3 to 11, m10 indicates an integer of from 1 to 3, preferably 1 or 2, more preferably 1; and when m10 is 2 or more, then the corresponding (—O—(CH₂)ₘ11)'S may be the same or different).

Y¹¹ represents a divalent, 4- to 7-membered ring residue, or a condensed ring residue composed of such rings; and m9 indicates an integer of from 1 to 3. Preferably, Y¹¹ is a 6-membered aromatic group, a 4- to 6-membered saturated or unsaturated aliphatic group, a 5- or 6-membered heterocyclic group, or their condensed ring. Preferred examples of Y₁₁ are the following substituents (Y-1) to (Y-30) and their combinations (including condensed rings). Of these substituents, more preferred are (Y-1), (Y-2), (Y-18), (Y-19), (Y-21), (Y-22) and (Y-29); and even more preferred are (Y-1), (Y-2), (Y-21) and (Y-29).

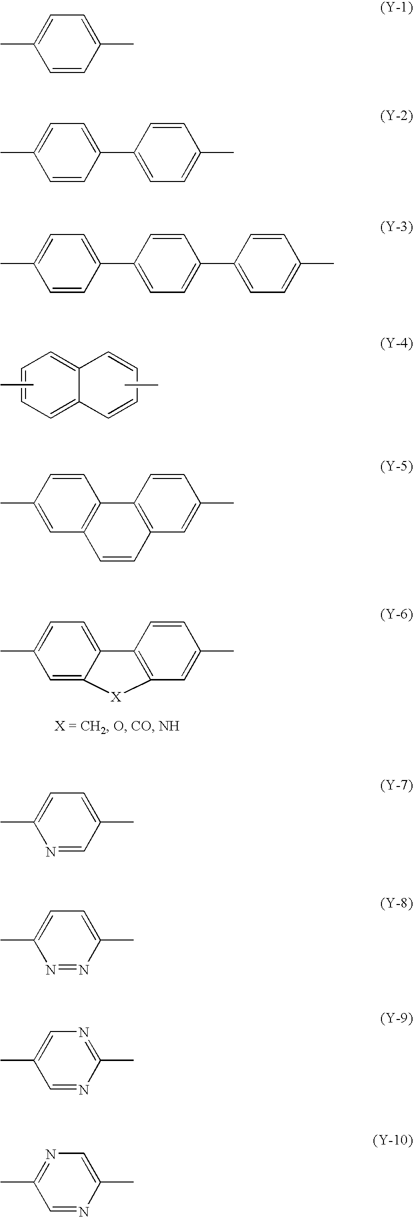

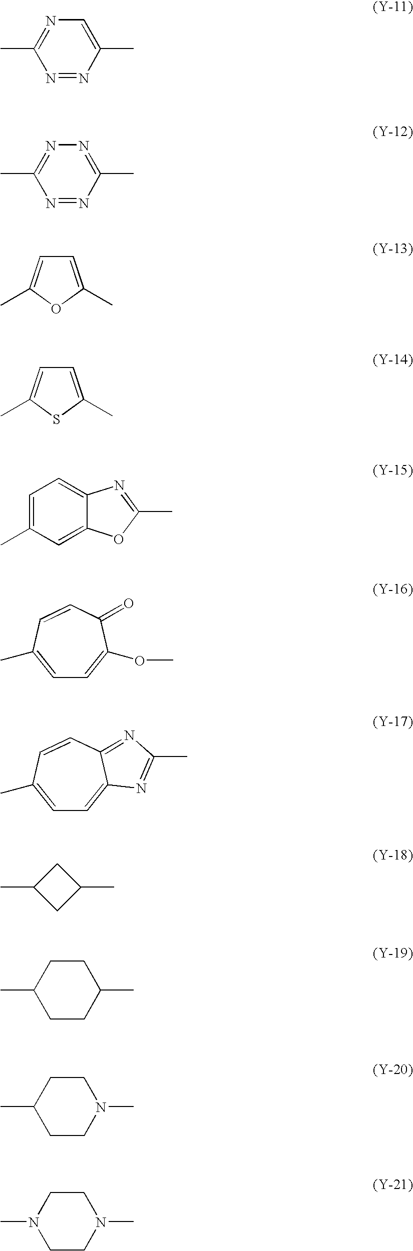

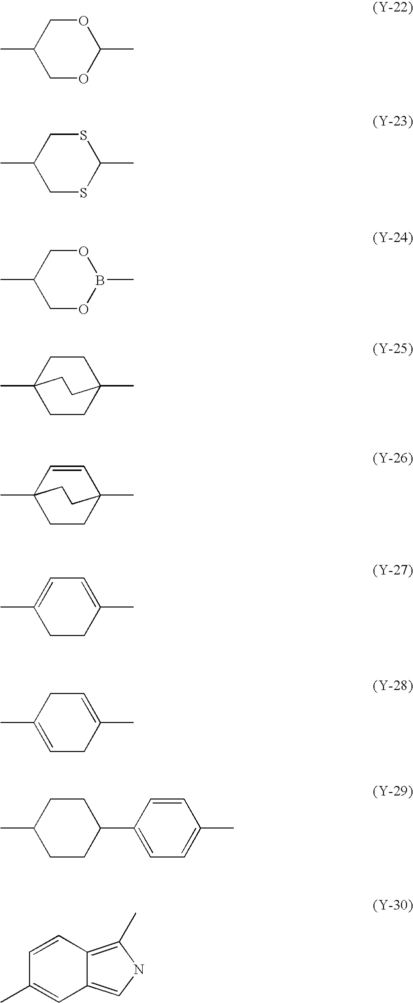

Preferably, the above-mentioned mesogen group-containing organic atomic group contains at least one alkyl or alkylene group having at least 5 carbon atoms, along with the mesogen therein, for enhancing the molecular orientation of the compound. Preferably, the alkyl or alkylene group has from 5 to 24 carbon atoms, more preferably from 6 to 16 carbon atoms. The alkyl or alkylene group in the organic atomic group may be substituted. Preferred examples of the substituent for the group are an alkyl group, an aryl group, a heterocyclic group, an alkoxy group, an acyloxy group, a cyano group, a fluoro group, and an alkoxycarbonyl group such as those mentioned hereinabove.

Y² represents a polymerizing group capable of forming a carbon-carbon or carbon-oxygen bond to produce a polymer. For example, it includes acryloyl, methacryloyl, vinyl and ethynyl groups, and alkylene oxides (e.g., ethylene oxide, trimethylene oxide). Of those, preferred are acryloyl, methacryloyl, ethylene oxide and trimethylene oxide groups.

In formulae (VII) and (VIII), the silyl group (—Si(OR¹⁰)ₘ₇(R⁹)₃₋ₘ₇, or —Si(OR¹²)ₘ₈(R¹¹)₃₋ₘ₈) directly bonds to the mesogen group, the alkylene group or the alkenylene group that constitutes the organic atomic group A³ or A⁴, or bonds thereto via a linking group. The linking group is preferably an alkylene group having from 1 to 15 carbon atoms, or a combination of such an alkylene group and the linking group Q¹¹, Q¹² of the mesogen. Preferably, the silyl group bonds to the alkylene group.

Preferably, the proportion of the mesogen-free organosilicon compound to the mesogen-containing organosilicon compound in the invention is from 5 to 300 mol %, more preferably from 10 to 200 mol %, even more preferably from 20 to 100 mol %.

Specific examples of the mesogen-containing organosilicon compound are mentioned below, to which, however, the invention is not limited. 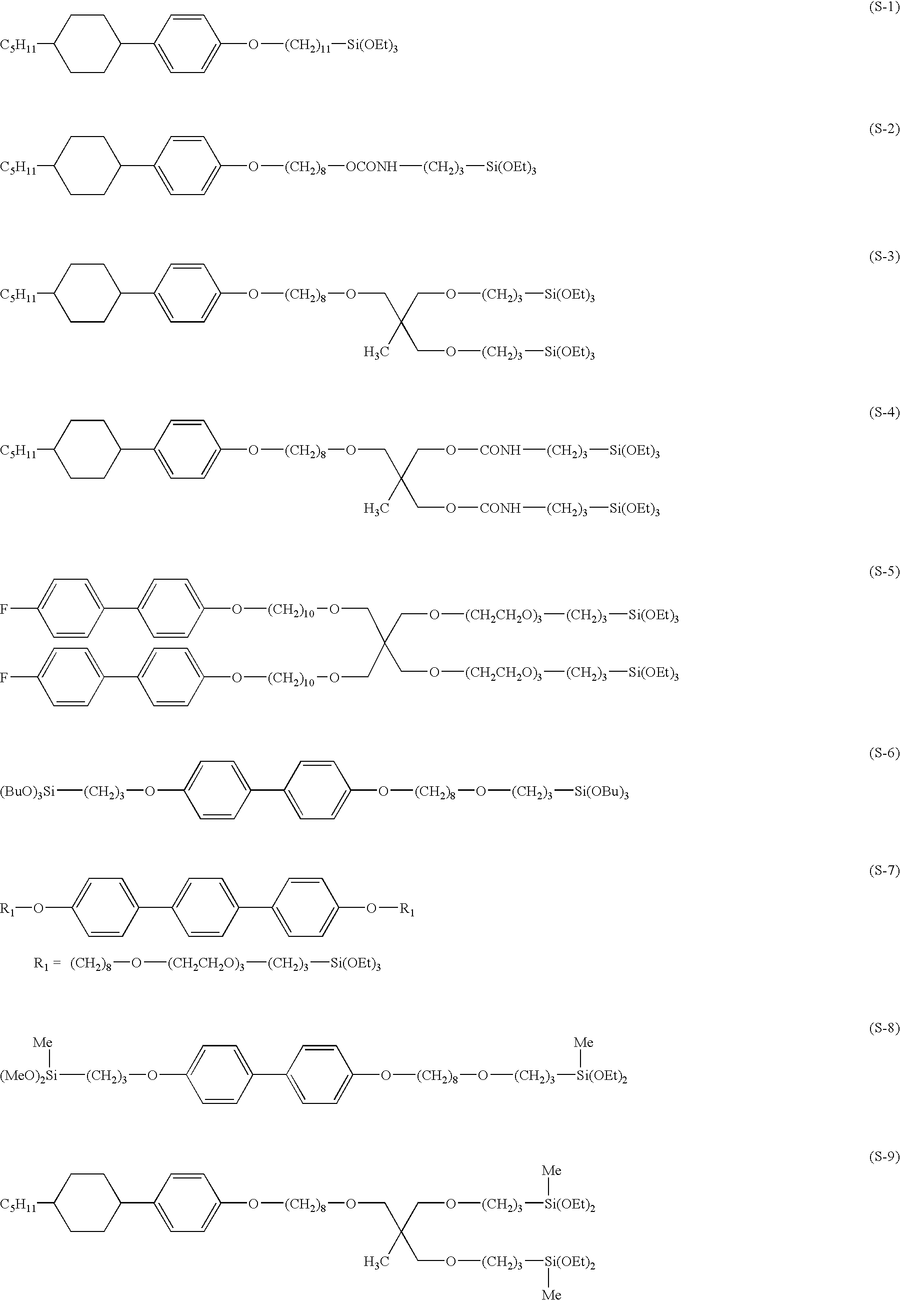 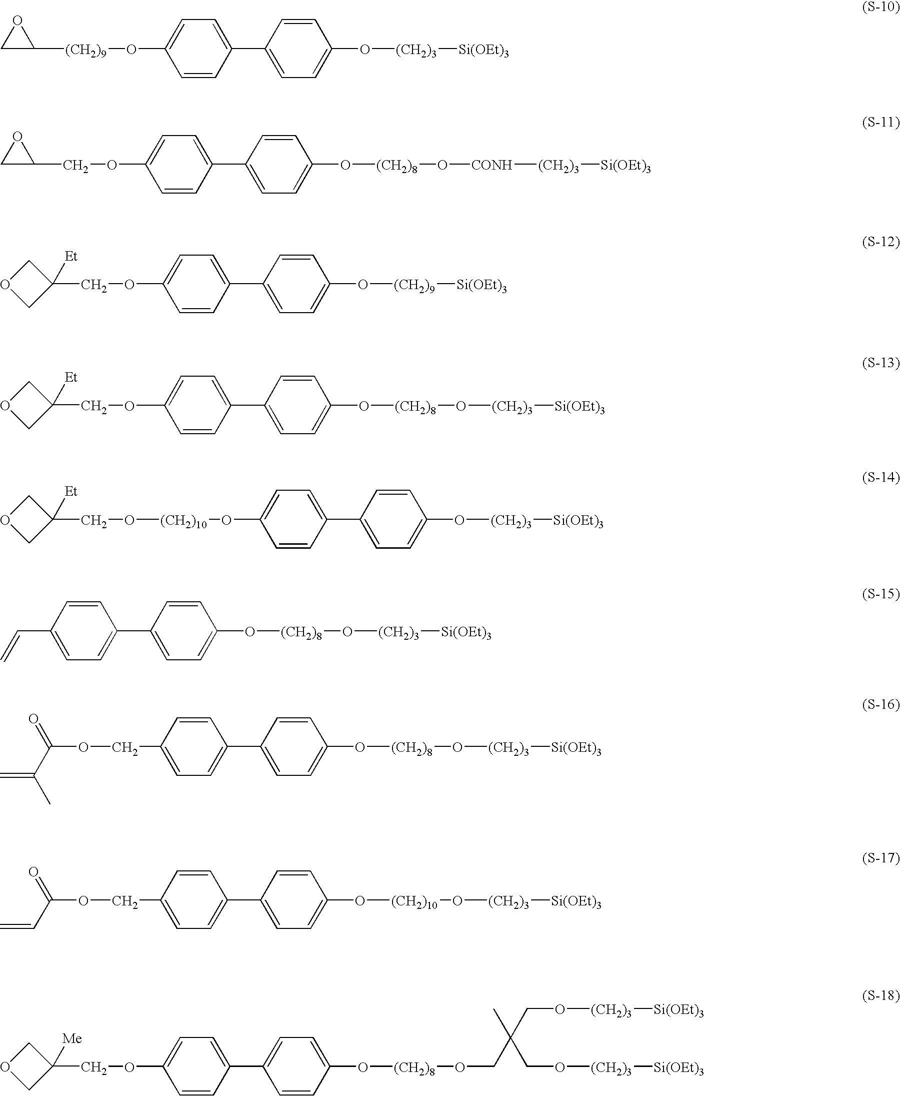 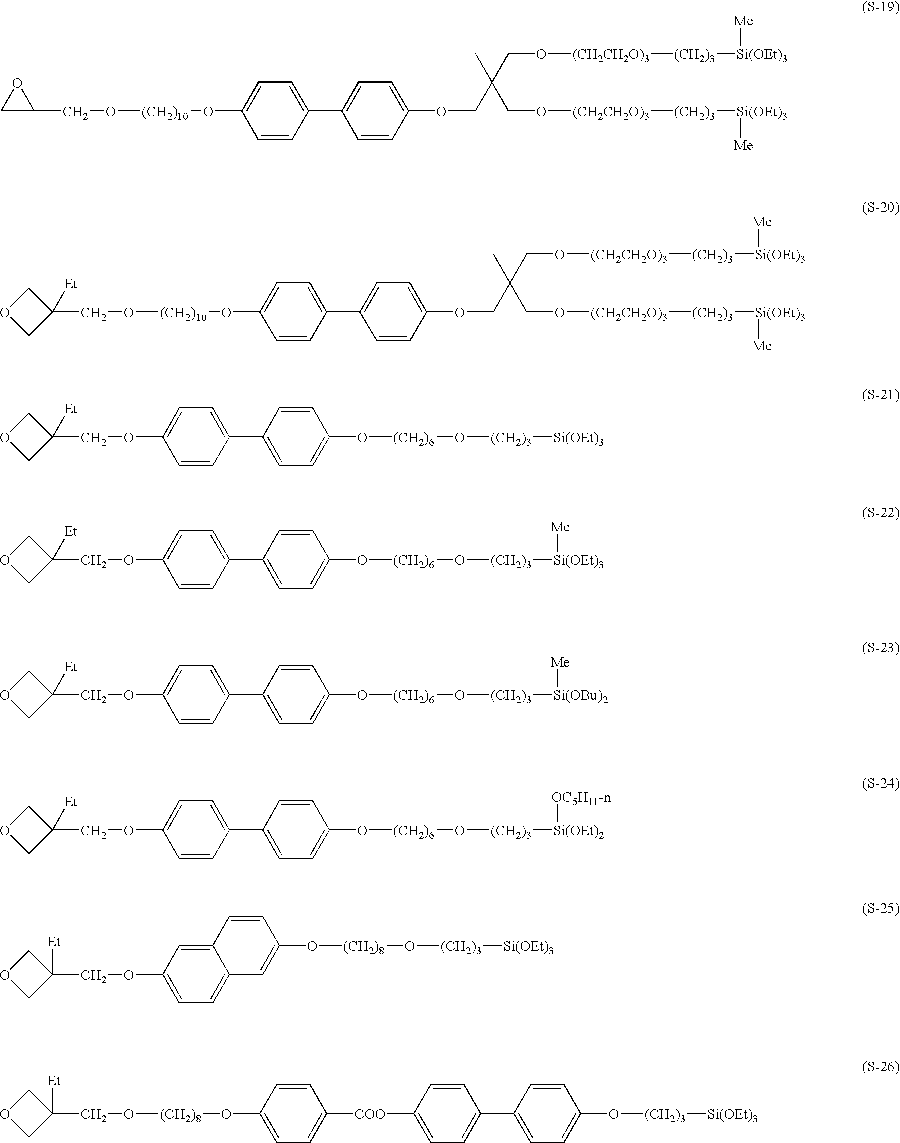 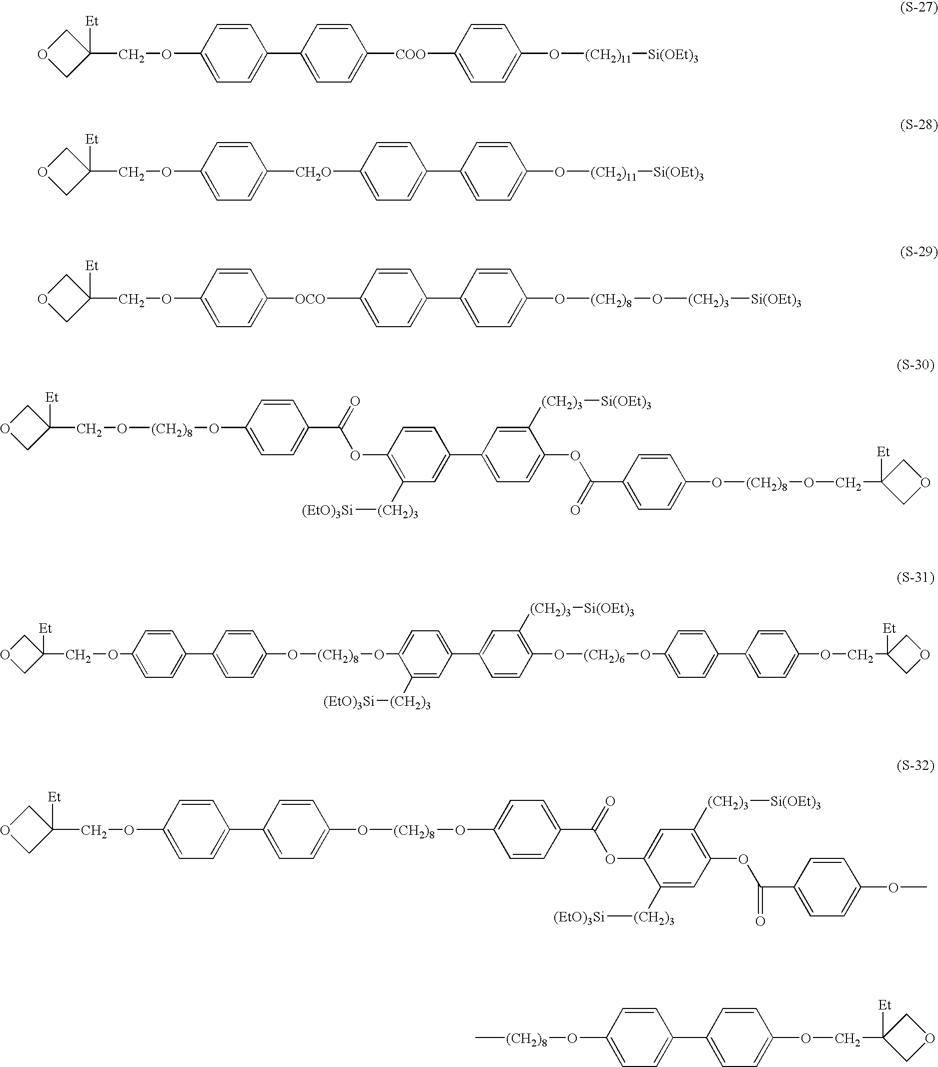 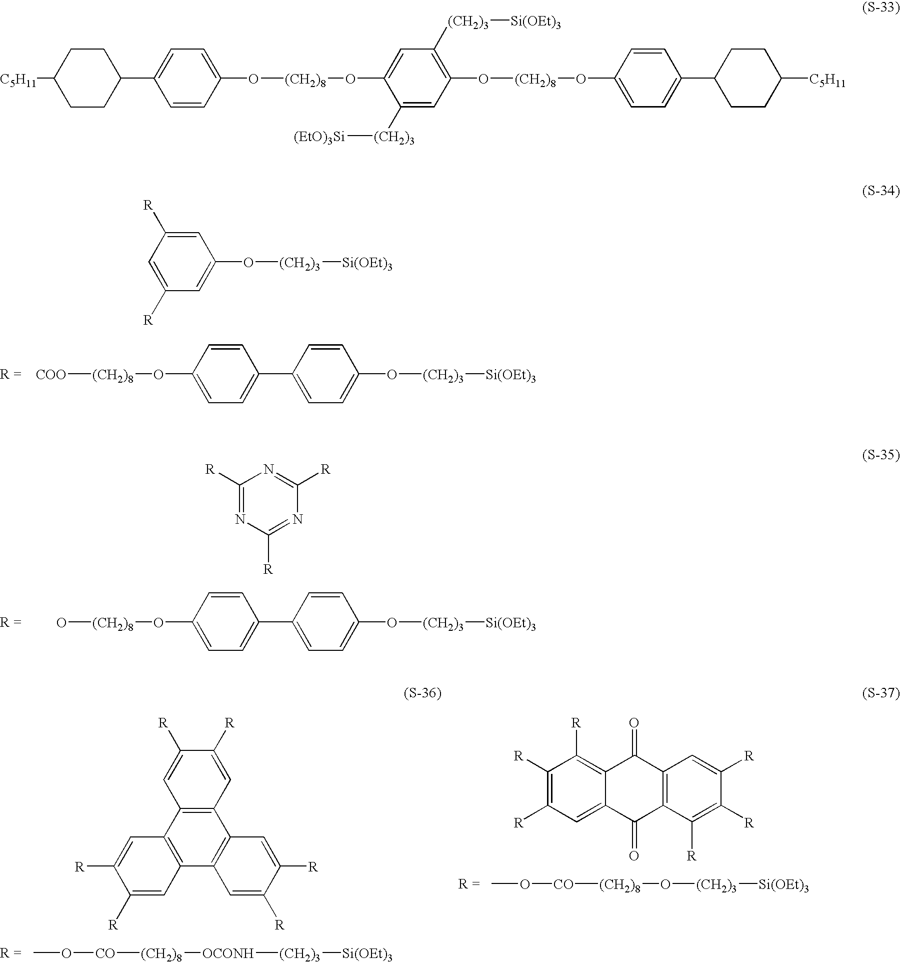 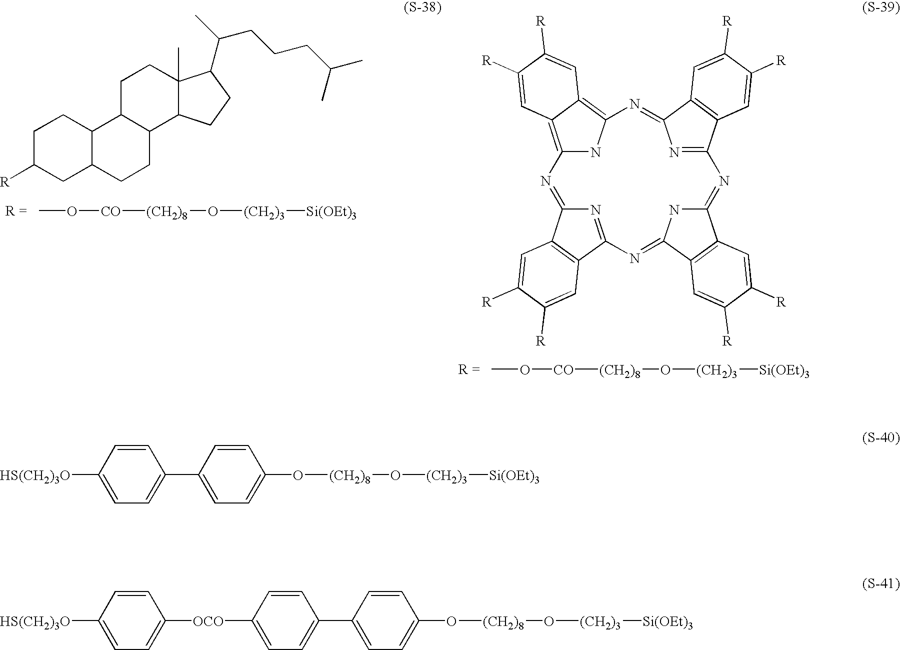
[2] Method of Forming Solid Electrolyte:
[2-1] Sol-Gel Process:

In the invention, generally employed is a sol-gel process that comprises metal alkoxide hydrolysis, condensation and drying (optionally firing) to give a solid. For example, herein employable are the methods described in JP-A10-69817, 11-203936, 2001-307752; Japanese Patent No. 3,103,888; German Patent DE 10061920A1; Electrochimica Acta, 1998, Vol. 43, Nos. 10-11, p. 1301; Industrial Materials, Nikkan KogyoShinbun-sha, 2002, Vol. 50, p. 39; and Solid State Ionics, 2001, No. 145, p. 127. An acid catalyst is generally used for condensation. However, in the invention, the precursors described in [1-1] may serve as acid catalysts, and the reaction does not require any additional acid to be added thereto.

One typical method of forming the solid electrolytic membrane of the invention comprises dissolving at least one compound of formulae (I), (III) and (IV) in a solvent (e.g., DMF, THF, dioxane, methylene chloride, diethyl ether) and reacting it with a sulfonating reagent. After the sulfonation, this is mixed with a mesogen-containing organosilicon compound of [1-3] optionally dissolved in a solvent to thereby promote alkoxysilyl hydrolysis and polycondensation (this is hereinafter referred to as “sol-gel” reaction). Alternatively, at least one compound of formulae (I), (III) and (IV) and a mesogen-containing organosilicon compound of [1-3] are dissolved in a solvent, and a sulfonating reagent is added to it for sulfo group introduction thereinto, and then the sol-gel reaction is promoted. In these reactions, the system may be heated, if desired. The viscosity of the reaction mixture (sol) gradually increases, and after the solvent is evaporated away and the remaining sol is dried, then a solid (gel) is obtained. While fluid, the sol may be cast into a desired vessel or applied onto a substrate, and thereafter the solvent is evaporated away and the remaining sol is dried to give a solid membrane. For further densifying the silica network formed therein, the membrane may be optionally heated after dried. After at least one compound of formulae (I), (III) and (IV) and a mesogen-containing organosilicon compound of [1-3] are dissolved in a solvent, the reaction product obtained through sol-gel reaction may be processed with a sulfonating reagent for sulfo group introduction thereinto to form a membrane.

The solvent for the sol-gel reaction is not specifically defined so far as it dissolves the organosilicon compound precursors. For it, however, preferred are carbonate compounds (e.g., ethylene carbonate, propylene carbonate), heterocyclic compounds (e.g., 3-methyl-2-oxazolidinone, N-methylpyrrolidone), cyclic ethers (e.g., dioxane, tetrahydrofuran), linear ethers (e.g., diethylether, ethylene glycol dialkyl ether, propylene glycol dialkyl ether, polyethylene glycol dialkyl ether, polypropylene glycol dialkyl ether), alcohols (e.g., methanol, ethanol, isopropanol, ethylene glycol monoalkyl ether, propylene glycol monoalkyl ether, polyethylene glycol monoalkyl ether, polypropylene glycol monoalkyl ether), polyalcohols (e.g., ethylene glycol, propylene glycol, polyethylene glycol, polypropylene glycol, glycerin), nitrile compounds (e.g., acetonitrile, glutarodinitrile, methoxyacetonitrile, propionitrile, benzonitrile), esters (e.g., carboxylates, phosphates, phosphonates), aprotic polar substances (e.g., dimethylsulfoxide, sulforane, dimethylformamide, dimethylacetamide), non-polar solvents (e.g., toluene, xylene), chlorine-containing solvents (e.g., methylene chloride, ethylene chloride), water, etc. Above all, especially preferred are alcohols such as ethanol, isopropanol, fluoroalcohols; nitrile compounds such as acetonitrile, glutarodinitrile, methoxyacetonitrile, propionitrile, benzonitrile; and cyclic ethers such as dioxane, tetrahydrofuran. One or more of these may be used herein either singly or as combined. For controlling the drying speed, a solvent having a boiling point of not lower than 100° C., such as N-methylpyrrolidone, dimethylacetamide, sulforane or dioxane, may be added to the above-mentioned solvent. The total amount of the solvent is preferably from 0.1 to 100 g, more preferably from 1 to 10 g, per gram of the precursor compound.

For promoting the sol-gel reaction, an acid catalyst may be used. Preferably, the acid catalyst is an inorganic or organic proton acid. The inorganic proton acid includes, for example, hydrochloric acid, sulfuric acid, phosphoric acids (e.g., H₃PO₄, H₃PO₃, H₄P₂O₇, H₅P₃O₁₀, metaphosphoric acid, hexafluorophosphoric acid), boric acid, nitric acid, perchloric acid, tetrafluoroboric acid, hexafluoroarsenic acid, hydrobromic acid, solid acids (e.g., tungstophosphoric acid, tungsten-peroxo complex). For the organic proton acid, for example, usable are low-molecular compounds such as phosphates (for example, those with from 1 to 30 carbon atoms, such as methyl phosphate, propyl phosphate, dodecyl phosphate, phenyl phosphate, dimethyl phosphate, didodecyl phosphate), phosphites (for example, those with from 1 to 30 carbon atoms, suchasmethylphosphite, dodecylphosphite, diethylphosphite, diisopropyl phosphite, didodecyl phosphite), sulfonic acids (for example, those with from 1 to 15 carbon atoms, such as benzenesulfonic acid, toluenesulfonic acid, hexafluorobenzenesulfonic acid, trifluoromethanesulfonic acid, dodecylsulfonic acid), carboxylic acids (for example, those with from 1 to 15 carbon atoms, such as acetic acid, trifluoroacetic acid, benzoic acid, substituted benzoic acids), imides (e.g., bis(trifluoromethanesulfonyl)imido acid, trifluoromethanesulfonyltrifluoroacetamide), phosphonic acids (for example, those with from 1 to 30 carbon atoms, such as methylphosphonic acid, ethylphosphonic acid, phenylphosphonic acid, diphenylphosphonic acid, 1,5-naphthalenebisphosphonic acid); and proton acid segment-having high-molecular compounds, for example, perfluorocarbonsulfonic acid polymers such as typically Nafion®, poly(meth)acrylates having a phosphoric acid group in side branches (JP-A 2001-114834), and sulfonated, heat-resistant aromatic polymers such as sulfonated polyether-ether ketones (JP-A 6-93111), sulfonated polyether sulfones (JP-A 10-45913), sulfonated polysulfones (JP-A 9-245818). Two or more of these may be used herein, as combined.

The reaction temperature in the sol-gel reaction is associated with the reaction speed, and it may be suitably determined depending on the reactivity of the precursors to be reacted and on the type and the amount of the acid used. Preferably, it falls between −20 and 150° C., more preferably between 0 and 80° C., even more preferably between 20 and 60° C.

[2-2] Polymerization of Polymerizing Group:

When the polymerizing group (Y¹ or Y²) is a carbon-carbon unsaturated bond-having group, for example, a (meth)acryloyl, vinyl or ethynyl group, then radical polymerization for ordinary polymer production may apply to the case. The process is described in Takayuki Ohtsu & Masaetsu Kinoshita, Experimental Process for Polymer Production (by Kagaku Doj in), and Takayuki Ohtsu, Lecture of Polymerization Theory 1, Radical Polymerization (1) (by Kagaku Dojin).

The radical polymerization includes thermal polymerization with a thermal polymerization initiator and photopolymerization with a photopolymerization initiator. Preferred examples of the thermal polymerization initiator are azo-type initiators such as 2,2′-azobis(isobutyronitrile), 2,2′-azobis(2,4-dimethylvaleronitrile), dimethyl 2,2′-azobis(2-methylpropionate); and peroxide-type initiators such as benzoyl peroxide. Preferred examples of the photopolymerization initiator are α-carbonyl compounds (U.S. Pat. Nos. 2,367,661 and 2,367,670), acyloin ethers α-hydrocarbon-substituted aromatic acyloin compounds (U.S. Pat. No. 2,722,512), polynuclear quinone compounds (U.S. Pat. Nos. 3,046,127 and 2,951,758), combinations of triarylimidazole dimer and p-aminophenyl ketone acridine and phenazine compounds (JP-A 60-105667, U.S. Pat. No. 4,239,850), and oxadiazole compounds (U.S. Pat. No. 4,212,970).

The polymerization initiator may be added to the reaction system before the start of the sol-gel reaction in the above [2-1], or may be added to the reaction product after the sol-gel reaction and immediately before the application of the reaction product to substrates. Preferably, the amount of the polymerization initiator to be added is from 0.01 to 20% by mass, more preferably from 0.1 to 10% by mass relative to the total amount of the monomers.

When the polymerizing group Y¹ or Y² is an alkylene oxide group such as ethylene oxide or trimethylene oxide, then the polymerization catalyst to be used in the case may be a proton acid (as in the above [2-1]), or a Lewis acid (preferably, boron trifluoride (including its ether complex), zinc chloride, aluminium chloride). In case where the proton acid used in the sol-gel reaction serves also as the polymerization catalyst, then it does not require any additional proton acid specifically for the polymerization of the polymerizing group Y¹ or Y² When used, the polymerization catalyst is preferably added to the reaction product just before the product is applied to substrates. In general, the polymerization is promoted in the membrane being formed on substrates through exposure of the membrane to heat or light. With that, the molecular orientation in the membrane is fixed and the membrane strength is thereby enhanced.

[2-3] Combination with Other Silicon Compound:

If desired, two or more precursors described in the above [1-1] to [1-3] may be mixed for use herein for improving the properties of the membranes formed. For example, at least one compound of formulae (I), (III) and (IV) is mixed with a compound of formulae (VII) and/or (VIII); or at least one compound of formulae (I), (III) and (IV) is mixed with two or more different compounds of formulae (VII) and/or (VIII) to form more flexible membranes. Optionally, any other silicon compound may be further added to these precursors. Examples of the additional silicon compound are organosilicon compounds of the following general formula (X), and their polymers. 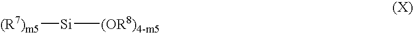
wherein R⁷ represents a substituted or unsubstituted alkyl, aryl or heterocyclic group; R⁸ represents a hydrogen atom, an alkyl group, an aryl group, or a silyl group; m5 indicates an integer of from 0 to 4; when m5 or (4-m5) is 2 or more, then R⁷'s or R⁸'s may be the same or different. The compounds of formula (X) may bond to each other at R⁷ or at the substituent on R⁷ to form polymers.

In formula (X), m5 is preferably from 0 to 2, and R⁸ is preferably an alkyl group. Examples of preferred compounds where m5 is 0 are tetramethoxysilane (TMOS) and tetraethoxysilane (TEOS). Examples of preferred compounds where m5 is 1 or 2 are mentioned below.

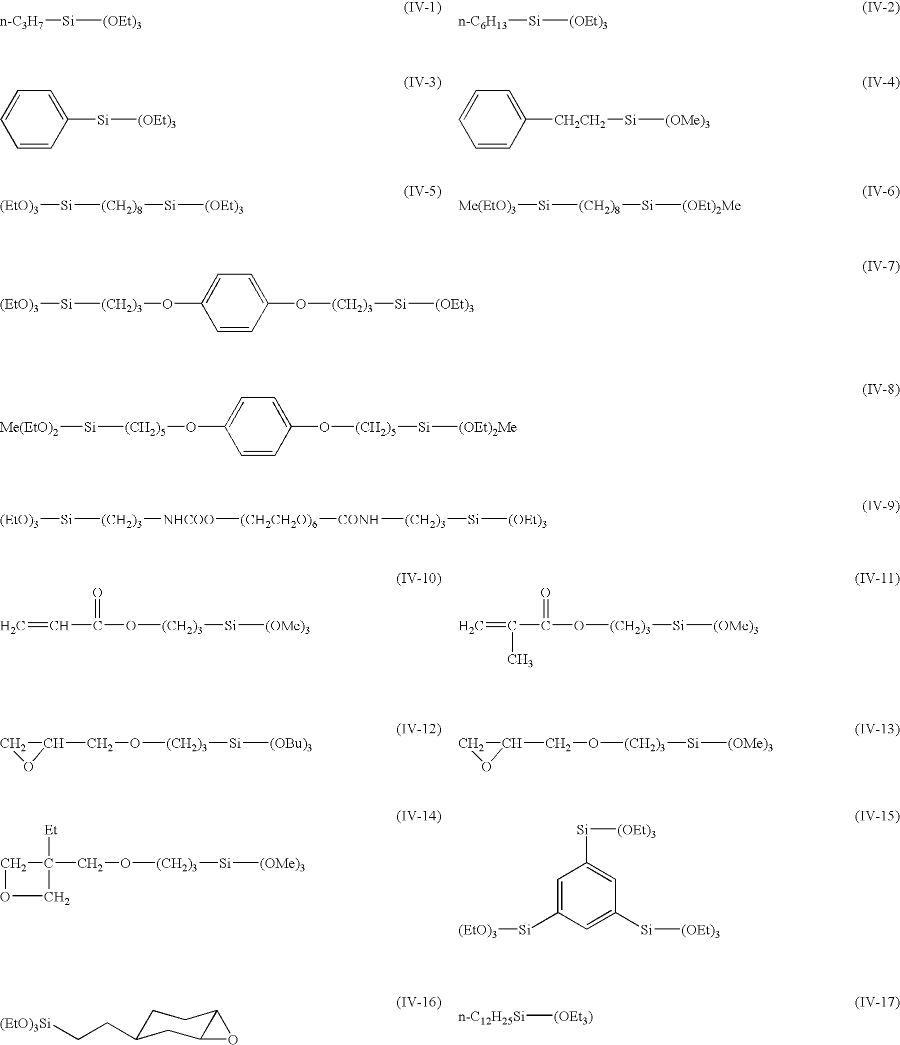

When the compound of formula (X) is combined with the organosilicon compound precursors, then its amount is preferably from 1 to 50 mol %, more preferably from 1 to 20 mol % of the precursors.

[2-4] Addition of Polymer Compound:

The solid electrolytic membrane of the invention may contain various polymer compounds for the purpose of (1) enhancing the mechanical strength of the membrane, and (2) increasing the acid concentration in the membrane. (1) For enhancing the mechanical strength of the membrane, preferably added thereto is a polymer compound having a molecular weight of from 10,000 to 1,000,000 or so and well compatible with the solid electrolyte of the invention. For example, the polymer compound includes perfluoropolymer, polystyrene, polyethylene glycol, polyoxetane, poly(meth)acrylate, polyether ketone, polyether sulfone, poly, and their copolymers. Preferably, the polymer content of the membrane is from 1 to 30% by mass. (2) For increasing the acid concentration in the membrane, preferably used herein are proton acid segment-having polymer compounds, for example, perfluorocarbonsulfonic acid polymers such as typically Nafion®, poly(meth)acrylates having a phosphoric acid group in the side branches, and sulfonated, heat-resistant aromatic polymers such as sulfonated polyether-ether ketones, sulfonated polyether sulfones, sulfonated polysulfones, sulfonated polybenzimidazoles. The content of the polymer compound in the membrane is preferably from 1 to 30% by mass.

The sol-gel reaction of the organosilicon compound precursor goes on while the organic site of the organosilicon compound is oriented after the sol-gel reaction mixture that contains the precursor is applied onto a substrate. To promote the orientation of the sol-gel composition, various methods may be employed. For example, supports such as those mentioned above may be previously oriented. The orientation may be effected in any ordinary method. Preferably, an orientable liquid-crystal layer of, for example, various orientable polyimide films or polyalcohol films is formed on a support, and rubbed for orientation; or the sol-gel composition applied on a support is put in a magnetic field or an electric field, or it is heated.

Regarding the orientation condition of the organic-inorganic hybrid solid electrolytic membrane, it is confirmed through observation with a polarizing microscope that the membrane is optically anisotropic. The direction in which the membrane sample is observed may be any one, not specifically defined. For example, when the sample rotated in a cross-Nicol condition gives changing dark and light shadows, then it can be said that the sample is anisotropic. The orientation condition of the membrane is not specifically defined provided that the membrane shows anisotropy. When a texture that can be recognized as a liquid-crystal phase is observed in the membrane sample, then the phase may be specifically identified. In this case, the phase may be any of a lyotropic liquid-crystal phase or a thermotropic liquid-crystal phase. Regarding its orientation condition, the lyotropic liquid-crystal phase is preferably a hexagonal phase, a cubic phase, a lamella phase, a sponge phase or a micelle phase. Especially at room temperature, preferred is a lamella phase or a sponge phase. The thermotropic liquid-crystal phase is preferably any of a nematic phase, a smectic phase, a crystal phase, a columnar phase and a cholesteric phase. Especially at room temperature, preferred are a smectic phase and a crystal phase. Also preferably, these phases may be oriented and fixed in solid. Anisotropy as referred to herein means that the directional vector of molecules is not isotropic.

The thickness of the organic-inorganic hybrid solid electrolytic membrane that is obtained by peeling it from the support is preferably from 10 to 500 μm, more preferably from 25 to 100 μm.

[2-5] Method of Film Formation:

The supports to which the sol-gel reaction mixture is applied in the invention are not specifically defined, and their preferred examples are glass substrates, metal substrates, polymer films and reflectors. Examples of the polymer films are cellulose polymer films of TAC (triacetyl cellulose), ester polymer films of PET (polyethylene terephthalate) or PEN (polyethylene naphthalate), fluoropolymer films of PTFE (polytrifluoroethylene), and polyimide films. Any known method of, for example, curtain coating, extrusion coating, roll coating, spin coating, dipping, bar coating, spraying, slide coating or printing is herein employable for applying the sol-gel reaction mixture to the supports.

[2-6] Filling to Porous Membrane:

The solid electrolyte of the invention may be infiltrated into the pores of a porous substrate to form a film. The sol-gel reaction solution of the invention is applied to a porous substrate so that it is infiltrated into the pores of the substrate, or such a porous substrate is dipped in the sol-gel reaction solution to thereby fill the pores with the proton-conductive material to form a film. Preferred examples of such a porous substrate are porous polypropylene, porous polytetrafluoroethylene, porous crosslinked heat-resistant polyethylene and porous polyimide films.

[2-7] Addition of Catalyst Metal to Solid Electrolytic Membrane:

An active metal catalyst may be added to the solid electrolytic membrane of the invention for promoting the redox reaction of anode fuel and cathode fuel. The fuel having penetrated into the solid electrolytic membrane that contains the catalyst may be well consumed inside the solid electrolytic membrane, not reaching any other electrode, and this is effective for preventing crossover. The active metal for the catalyst is not specifically defined provided that it functions as an electrode catalyst. For it, for example, suitable is platinum or platinum-based alloy.

[3] Fuel Cell:

[3-1] Cell Structure:

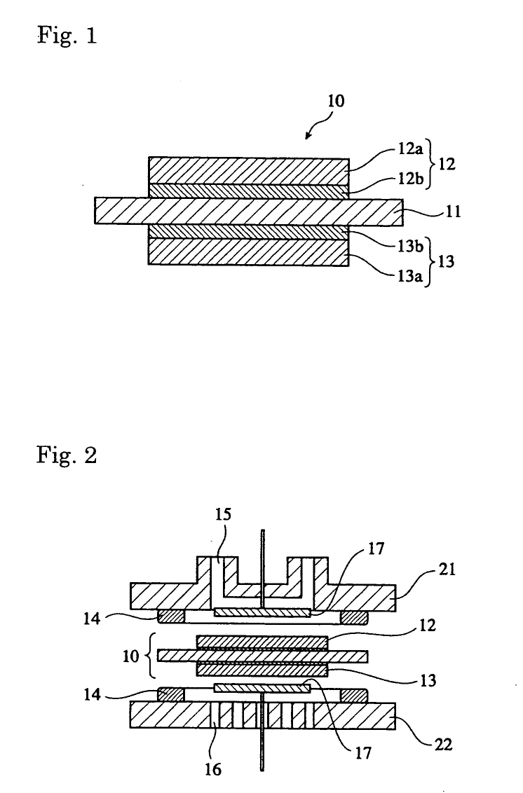

A fuel cell is described, which comprises solid electrolytic membrane of the invention. FIG. 1 shows the constitution of a membrane electrode assembly (hereinafter referred to as “MEA”) 10 for use in fuel cells. The MEA 10 comprises a solid electrolytic membrane 11, and an anode 12 and a cathode 13 that are opposite to each other via the membrane 11.

The anode 12 and the cathode 13 comprise a porous conductive sheet for anode (e.g., carbon paper) 12a, a porous conductive sheet for cathode 13a, an anode catalyst layer 12b, and a cathode catalyst layer 13b. The anode catalyst layer 12b and the cathode catalyst layer 13b are formed of a dispersion of carbon particles (e.g., ketjen black, acetylene black, carbon nanotubes) that carry a catalyst metal such as platinum particles thereon, in a solid electrolytic membrane (e.g., Nafion). For airtightly adhering the anode catalyst layer 12b and the cathode catalyst layer 13b to the solid electrolytic membrane 11, generally employed is a method of hot-pressing the porous conductive sheet for anode 12a and the porous conductive sheet for cathode 13a coated with the anode catalyst layer 12b and the cathode catalyst layer 13b, respectively, against the solid electrolytic membrane 11 (preferably at 120 to 130° C. under 2 to 100 kg/cm²); or a method of pressing the anode catalyst layer 12b and the cathode catalyst layer 13b each formed on a suitable support, against the solid electrolytic membrane 11 while transferring the layers onto the membrane, followed by making the resulting laminate structure sandwiched between the porous conductive sheet for anode 12a and the porous conductive sheet for cathode 13a.

FIG. 2 shows one example of a fuel cell. The fuel cell comprises the MEA 10, a pair of separators 21, 22 between which the MEA 10 is sandwiched, and a collector 17 of a stainless net and a gasket 14 both fitted to the separators 21, 22. The anode-side separator 21 has an anode-side opening 15 formed through it; and the cathode-side separator 22 has a cathode-side opening 16 formed through it. Vapor fuel such as hydrogen or alcohol (e.g., methanol) or liquid fuel such as aqueous alcohol solution is fed to the cell via the anode-side opening 15; and an oxidizing gas such as oxygen gas or air is thereto via the cathode-side opening 16.

[3-2] Catalyst Material:

For the anode and the cathode, for example, a catalyst that carries active metal particles of platinum or the like on a carbon material may be used. The particle size of the active metal particles that are generally used in the art is from 2 to 10 nm. Active metal particles having a smaller particle size may have a large surface area per the unit mass thereof, and are therefore advantageous since their activity is higher. If too small, however, the particles are difficult to disperse with no aggregation, and it is said that the lowermost limit of the particle size will be 2 nm or so.

In hydrogen-oxygen fuel cells, the active polarization of anode (hydrogen electrode) is higher than that of cathode (air electrode). This is because the cathode reaction (oxygen reduction) is slow as compared with the anode reaction. For enhancing the oxygen electrode activity, usable are various platinum-based binary alloys such as Pt—Cr, Pt—Ni, Pt—Co, Pt—Cu, Pt—Fe. In a direct methanol fuel cell in which aqueous methanol is used for the anode fuel, it is a matter of importance that the catalyst poisoning with CO that is formed during methanol oxidation must be inhibited. For this purpose, usable are platinum-based binary alloys such as Pt—Ru, Pt—Fe, Pt—Ni, Pt—Co, Pt—Mo, and platinum-based ternary alloys such as Pt—Ru—Mo, Pt—Ru—W, Pt—Ru—Co, Pt—Ru—Fe, Pt—Ru—Ni, Pt—Ru—Cu, Pt—Ru—Sn, Pt—Ru—Au.

For the carbon material that carries the active metal thereon, preferred are acetylene black, Vulcan XC-72, ketjen black, carbon nanohorns (CNH), carbon nanotubes (CNT).

[3-3] Constitution and Material of Catalyst Layer:

The function of the catalyst layer includes (1) transporting fuel to active metal, (2) providing the reaction site for oxidation of fuel (anode) and for reduction thereof (cathode), (3) transmitting the electrons formed through the redox reaction to collector, and (4) transporting the protons formed through the reaction to solid electrolytic membrane. For (1), the catalyst layer must be porous so that liquid and vapor fuel may penetrate into the depth thereof. The active metal catalyst mentioned in [3-2] acts for (2); and the carbon material also mentioned in [3-2] acts for (3). For attaining the function of (4), the catalyst layer shall contain a solid electrolyte added thereto.

The solid electrolyte to be in the catalyst layer is not specifically defined provided that it is a solid that has a proton-donating group. For it, for example, preferred are acid reside-having polymer compounds that are used for the solid electrolytic membrane (e.g., perfluorocarbonsulfonic acids such as typically Nafion; phosphoric acid-branched poly(meth)acrylates; sulfonated, heat-resistant aromatic polymers such as sulfonated polyether-ether ketones, sulfonated polybenzimidazoles), and acid-fixed organic-inorganic hybrid proton-conductive materials (e.g., proton-conductive materials as in the above-mentioned references). As the case may be, the solid electrolyte that is obtained through sol-gel reaction of the precursor (compound of formula (I)) for the solid electrolytic membrane of the invention may also be used for the catalyst layer. This is favorable, since the solid electrolytic membrane and the catalyst layer are formed of a material of the same type, the adhesiveness between the solid electrolytic membrane and the catalyst layer is high.

The amount of the active metal to be used herein is preferably from 0.03 to 10 mg/cm² from the viewpoint of the cell output and from the economical viewpoint. The amount of the carbon material that carries the active metal is preferably from 1 to 10 times the mass of the active metal. The amount of the solid electrolyte is preferably from 0.1 to 0.7 times the mass of the active metal-carrying carbon.

[3-4] Porous Conductive Sheet (Electrode Substrate):

The porous conductive sheet may be referred to as an electrode substrate, a diffusive layer or a lining material, and it acts as a collector and also acts to prevent water from staying therein to worsen vapor diffusion. In general, carbon paper or carbon cloth may be used for the sheet. If desired, the sheet may be processed with PTFE so as to be repellent to water.

[3-5] Formation of MEA (Membrane Electrode Assembly):

For forming MEA, preferred are the following four methods:

Solid electrolytic membrane coating method: A catalyst paste (ink) that comprises basic ingredients of active metal-carrying carbon, solid electrolyte, proton-conductive material and solvent is directly applied onto both sides of a solid electrolytic membrane, and a porous conductive sheet is (thermally) adhered under pressure thereto to construct a 5-layered MEA.

Porous conductive sheet coating method: The catalyst paste is applied onto the surface of a porous conductive sheet to form a catalyst layer thereon, and a solid electrolytic membrane is adhered thereto under pressure to construct a 5-layered MEA.

Decal method: The catalyst paste is applied onto PTFE to form a catalyst layer thereon, and the catalyst layer alone is transferred to a solid electrolytic membrane to construct a 3-layered MEA. A porous conductive sheet is adhered thereto under pressure to construct a 5-layered MEA.

Catalyst post-carrying method: Ink prepared by mixing a platinum powder-carrying carbon material and a solid electrolyte is applied onto a solid electrolytic membrane, a porous conductive sheet or PTFE to form a film, and platinum ions are infiltrated into the film and platinum particles are precipitated in the film through reduction to thereby form a catalyst layer. After the catalyst layer is formed, the catalyst layer alone is transferred onto a solid electrolytic membrane to construct a 3-layered MAE, and a porous conductive sheet is adhered thereto under pressure to construct a 5-layered MEA.

[3-6] Fuel and Method of Fuel Supply:

Fuel for fuel cells that comprise a solid electrolytic membrane is described. For anode fuel, usable are hydrogen, alcohols (e.g., methanol, isopropanol, ethylene glycol), ethers (e.g., dimethyl ether, dimethoxymethane, trimethoxymethane), formic acid, boron hydride complexes, ascorbic acid, etc. For cathode fuel, usable are oxygen (including oxygen in air), hydrogen peroxide, etc.

In direct methanol fuel cells, the anode fuel may be aqueous methanol having a methanol concentration of from 3 to 64% by mass. As in the anode reaction formula (CH₃OH+H₂O →CO₂+6H⁺+6e⁻), 1 mol of methanol requires 1 mol of water, and the methanol concentration in the case corresponds to 64% by mass. A higher methanol concentration in fuel is more effective for reducing the mass and the volume of the cell including the fuel tank of the same energy capacity. However, if the methanol concentration is too high, then much methanol may penetrate through the solid electrolytic membrane to reach the cathode on which it react with oxygen to lower the voltage. This is a crossover phenomenon. When the methanol concentration is too high, then the crossover phenomenon is remarkable and the cell output lowers. To that effect, the optimum concentration of methanol shall be determined, depending on the methanol perviousness through the solid electrolytic membrane used. The cathode reaction formula in direct methanol fuel cells is (3/2 O₂+6H⁺+6e⁻→H₂O), and oxygen (generally, oxygen in air) is used for the fuel in the cells.

For supplying the anode fuel and the cathode fuel to the respective catalyst layers, for example, employable are two methods, (1) a method of forcedly circulating the fuel by the use of an auxiliary device such as pump (active method), and (2) a method not using such an auxiliary device (for example, liquid fuel is supplied through capillarity or by spontaneously dropping it, and vapor fuel is supplied by exposing the catalyst layer to air—passive method). If desired, these methods may be combined for anode and cathode. The method (1) has some advantages in that water formed in the cathode area is circulated, and high-concentration methanol is usable as fuel, and that air supply enables high output from the cells. However, this is problematic in that the necessary fuel supply unit will make it difficult to down-size the cells. On the other hand, the advantage of the method (2) is that it may make it possible to down-size the cells, but the disadvantage thereof is that the fuel supply rate is readily limited and high output from the cells is often difficult.

[3-7] Cell Stacking:

The unit cell voltage of fuel cells is generally at most 1 V. Therefore, it is desirable that many cells are stacked up in series, depending on the necessary voltage for load. For cell stacking, for example, employable are a method of “plane stacking” that comprises placing unit cells on a plane, and a method of “bipolar stacking” that comprises stacking up unit cells via a separator with a fuel pathway formed on both sides thereof. In the plane stacking, the cathode (air electrode) is on the surface of the stacked structure and it may readily take air thereinto. In this, since the stacked structure may be thinned, it is more favorable for small-sized fuel cells. Apart from these, MEMS may be employed, in which a silicon wafer is processed to form a micropattern and fuel cells are stacked on it.

[4] Fuel Cell Applications:

Fuel cells may have many applications, for example, for automobiles, electric and electronic appliances for household use, mobile devices, portable devices, etc. In particular, direct methanol fuel cells may be down-sized, the weight thereof may be reduced and they do not require charging. Having such many advantages, therefore, they are expected to be used for various energy sources for mobile appliances and portable appliances. For example, mobile appliances in which fuel cells are favorably used include mobile phones, mobile notebook-size personal computers, electronic still cameras, PDA, video cameras, mobile game drivers, mobile servers, wearable personal computers, mobile displays; and portable appliances in which fuel cells are favorably used include portable generators, outdoor lighting devices, pocket lamps, electrically-powered (or assisted) bicycles, etc. In addition, fuel cells are also favorable for power sources for robots for industrial and household use and for other toys. Moreover, they are further usable as power sources for charging secondary batteries that are mounted on these appliances.

The invention is described more concretely with reference to the following Examples. The materials, their amount and proportion, the processing modes and the processing orders may be varied and changed in any desired manner, not overstepping the scope and the sprit of the invention. Accordingly, the invention should not be limited to the following Examples.

### EXAMPLES

Example 1

### Formation of Solid Electrolytic Membrane:

### Example 1-1

(1) Formation of Solid Electrolytic Membrane (E-1-1):

SO₃-DMF complex (from Aldrich) (0.15 g) was added to a solution of DMF (0.5 ml) with A-14 (0.1 g) dissolved therein, and reacted at room temperature for 12 hours. Next, IV-2 (38 mg) and water (0.05 ml) were added to it, and stirred under heat at 60° C. for 4 hours. The resulting mixture was cast on a polyimide film (Upilex-75S by Ube Kosan), and left as such for 24 hours. Thus solidified, the coating film was peeled from the polyimide film, and washed with water. After dried, the film thus formed had a thickness of 120 μm.

(2) Formation of Solid Electrolytic Membrane (E-1-2):

SO₃-DMF complex (from Aldrich) (0.15 g) was added to a solution of DMF (0.5 ml) with A-14 (0.1 g) dissolved therein, and reacted at room temperature for 12 hours. Next, IV-5 (73 mg) and water (0.11 ml) were added to it, and stirred under heat at 60° C. for 4 hours. The resulting mixture was cast on a polyimide film (Upilex-75S by Ube Kosan), and left as such for 24 hours. Thus solidified, the coating film was peeled from the polyimide film, and washed with water. After dried, the film thus formed had a thickness of 110 μm.

(3) Formation of Solid Electrolytic Membrane (E-1-3):

SO₃-DMF complex (from Aldrich) (0.15 g) was added to a solution of DMF (0.5 ml) with A-14 (0.1 g) dissolved therein, and reacted at room temperature for 12 hours. Next, IV-8 (86 mg) and water (0.11 ml) were added to it, and stirred under heat at 60° C. for 4 hours. The resulting mixture was cast on a polyimide film (Upilex-75S by Ube Kosan), and left as such for 24 hours. Thus solidified, the coating film was peeled from the polyimide film, and washed with water. After dried, the film thus formed had a thickness of 110 μm.

(4) Formation of Solid Electrolytic Membrane (E-1-4):

SO₃-DMF complex (from Aldrich) (0.15 g) was added to a solution of DMF (0.5 ml) with A-14 (0.1 g) dissolved therein, and reacted at room temperature for 12 hours. Next, IV-13 (79 mg), TEOS (50 mg) and water (0.16 ml) were added to it, and stirred under heat at 60° C. for 4 hours. The resulting mixture was cast on a polyimide film (Upilex-75S by Ube Kosan), and left as such for 24 hours. Thus solidified, the coating film was peeled from the polyimide film, and washed with water. After dried, the white film thus formed had a thickness of 130 μm.

(5) Formation of Solid Electrolytic Membrane (E-1-5):

SO₃-DMF complex (from Aldrich) (0.13 g) was added to a solution of DMF (0.5 ml) with A-22 (0.1 g) dissolved therein, and reacted at room temperature for 12 hours. Next, IV-13 (68 mg) and water (0.09 ml) were added to it, and stirred under heat at 60° C. for 4 hours. The resulting mixture was cast on a polyimide film (Upilex-75S by Ube Kosan), and left as such for 24 hours. Thus solidified, the coating film was peeled from the polyimide film, and washed with water. After dried, the film thus formed had a thickness of 120 μm.

(6) Formation of Solid Electrolytic Membrane (E-1-6):

SO₃-DMF complex (from Aldrich) (0.18 g) was added to a solution of DMF (0.5 ml) with A-24 (0.1 g) dissolved therein, and reacted at room temperature for 12 hours. Next, IV-13 (92 mg) and water (0.13 ml) were added to it, and stirred under heat at 60° C. for 4 hours. The resulting mixture was cast on a polyimide film (Upilex-75S by Ube Kosan), and left as such for 24 hours. Thus solidified, the coating film was peeled from the polyimide film, and washed with water. After dried, the film thus formed had a thickness of 110 μm.

(7) Formation of Solid Electrolytic Membrane (E-1-7):

SO₃-DMF complex (from Aldrich) (0.11 g) was added to a solution of DMF (0.5 ml) with A-29 (0.1 g) dissolved therein, and reacted at room temperature for 12 hours. Next, IV-14 (67 mg) and water (0.08 ml) were added to it, and stirred under heat at 60° C. for 4 hours. The resulting mixture was cast on a polyimide film (Upilex-75S by Ube Kosan), and left as such for 24 hours. Thus solidified, the coating film was peeled from the polyimide film, and washed with water. After dried, the film thus formed had a thickness of 120 μm.

(8) Formation of Solid Electrolytic Membrane (E-1-8):

SO₃-DMF complex (from Aldrich) (0.31 g) was added to a solution of DMF (1 ml) with A-14 (0.1 g) and A-28 (0.13 g) dissolved therein, and reacted at room temperature for 12 hours. Next, water (0.11 ml) was added to it, and stirred under heat at 60° C. for 4 hours. The resulting mixture was cast on a polyimide film (Upilex-75S by Ube Kosan), and left as such for 24 hours. Thus solidified, the coating film was peeled from the polyimide film, and washed with water. After dried, the film thus formed had a thickness of 130 μm.

(9) Formation of Solid Electrolytic Membrane (E-1-9):

A-14 (0.1 g), IV-13 (79 mg) and TEOS (50 mg) were dissolved in ethanol, and 50 μl of 2% hydrochloric acid was added to it at 25° C. and stirred for 20 minutes. The resulting mixture was cast on a polyimide film (Upilex-75S by Ube Kosan), and left as such for 72 hours. The polyimide film was dipped in DMF (0.5 ml) with SO₃-DMF complex (from Aldrich) (0.15 g) dissolved therein, and the coating film was peeled from the polyimide film and washed with water. After dried, the film thus formed had a thickness of 130 μm.

(10) Formation of Solid Electrolytic Membrane (E-1-10):

SO₃-DMF complex (from Aldrich) (0.15 g) was added to a solution of DMF (0.5 ml) with A-14 (0.1 g) dissolved therein, and reacted at room temperature for 12 hours. Next, IV-13 (79 mg) and water (0.10 ml) were added to it, and stirred under heat at 50° C. for 4 hours. The resulting mixture was cast on a polyimide film (Upilex-75S by Ube Kosan), and left as such for 24 hours. Thus solidified, the coating film was peeled from the polyimide film, and washed with water. After dried, the film thus formed had a thickness of 130 μm.

(11) Formation of Solid Electrolytic Membrane (R-1-1):

IV-13 (800 mg) and TEOS (200 mg) were dissolved in ethanol, and 50 μl of 2% hydrochloric acid was added to it at 25° C. and stirred for 20 minutes. Phosphoric acid/isopropanol solution (phosphoric acid, H₃PO₄, 500 mg/isopropanol 1 ml) was added to the solution, and stirred at 25° C. for 30 minutes, and then this was applied to a Teflon sheet by the use of an applicator. This was left at room temperature for 2 hours, and then heated at 50° C. for 2 hours, and further at 80° C. for 3 hours. Next, this was peeled from the Teflon sheet, and a comparative transparent sheet solid (R-1-1) having a thickness of 85 μm was obtained.

(12) Formation of Solid Electrolytic Membrane (R-1-2):

A solution of SO₃ (80 mg) dissolved in 0.2 ml of methylene chloride was dropwise added to a methylene chloride (0.5 ml) solution of triethoxyphenylsilane (0.24 g). This was reacted at room temperature for 5 hours, and the solvent was evaporated away. An ethanol solution of IV-13 (0.24 g) and water were added to the resulting residue, and stirred at 60° C. for 4 hours. The resulting mixture was cast on a polyimide film (Upilex-75S by Ube Kosan), and left as such for 24 hours. Thus solidified, the coating film was peeled from the polyimide film, and washed with water. After dried, the film thus formed had a thickness of 130 μm.

(13) Formation of Solid Electrolytic Membrane (R-1-3):

3-Mercaptopropyltrimethoxysilane (0.19 g) and diethoxydimethylsilane (0.15 g) weredissolvedinethanol (0.5 ml), and 5011 of 2% hydrochloric acid was added to it and stirred at 50° C. for 3 hours. The solvent was evaporated away, and 0.15 g of a viscous oil was obtained. The oil was dissolved in methylene chloride, and cooled in an ice bath. m-chloroperbenzoic acid (0.67 g) was gradually added to it, and after the addition, this was warmed up to room temperature and stirred for 2 hours. A solid precipitated in the reaction solution, and no film was formed.

(14) Formation of Solid Electrolytic Membrane (R-1-4):

Based on the references described in Solid State Ionics, 2001, No. 145, p. 127, the following compound was produced, but it could not form a film.

### Example 1-2:

(1) Formation of Solid Electrolytic Membrane (E-2-1):

SO₃-DMF complex (from Aldrich) (0.15 g) was added to a solution of DMF (0.5 ml) with A-14 (0.1 g) dissolved therein, and reacted at room temperature for 12 hours. Next, S-13 (207 mg) and water (0.11 ml) were added to it, and stirred under heat at 60° C. for 4 hours. The resulting mixture was cast on a polyimide film (Upilex-75S by Ube Kosan), and left as such for 24 hours. Thus solidified, the coating film was peeled from the polyimide film, and washed with water. After dried, the white film thus formed had a thickness of 120 μm. With a polarizing microscope, fine domains of optical anisotropy were confirmed in the film. From this, it is understood that the mesogen part of S-13 aggregated in a predetermined direction and its aggregates formed the film.

(2) Formation of Solid Electrolytic Membrane (E-2-2):

SO₃-DMF complex (from Aldrich) (0.15 g) was added to a solution of DMF (0.5 ml) with A-14 (0.1 g) and S-13 (207 mg) dissolved therein, and reacted at room temperature for 12 hours. Next, water (0.11 ml) was added to it, and stirred under heat at 60° C. for 3 hours. The resulting mixture was cast on a polyimide film (Upilex-75S by Ube Kosan), and left as such for 24 hours. Thus solidified, the coating film was peeled from the polyimide film, and washed with water. After dried, the white film thus formed had a thickness of 120 μm. With a polarizing microscope, fine domains of optical anisotropy were confirmed in the film. From this, it is understood that the mesogen part of S-13 aggregated in a predetermined direction and its aggregates formed the film.

(3) Formation of Solid Electrolytic Membrane (E-2-3):

SO₃-DMF complex (from Aldrich) (0.15 g) was added to a solution of DMF (0.5 ml) with A-14 (0.1 g) dissolved therein, and reacted at room temperature for 12 hours. Next, S-21 (235 mg) and water (0.15 ml) were added to it, and stirred under heat at 60° C. for 4 hours. The resulting mixture was cast on a polyimide film (Upilex-75S by Ube Kosan), and left as such for 24 hours. Thus solidified, the coating film was peeled from the polyimide film, and washed with water. After dried, the white film thus formed had a thickness of 110 μm. With a polarizing microscope, fine domains of optical anisotropy were confirmed in the film. From this, it is understood that the mesogen part of S-21 aggregated in a predetermined direction and its aggregates formed the film.

(4) Formation of Solid Electrolytic Membrane (E-2-4):

SO₃-DMF complex (from Aldrich) (0.15 g) was added to a solution of DMF (0.5 ml) with A-22 (0.1 g) dissolved therein, and reacted at room temperature for 12 hours. Next, S-13 (177 mg) and water (0.09 ml) were added to it, and stirred under heat at 60° C. for 4 hours. The resulting mixture was cast on a polyimide film (Upilex-75S by Ube Kosan), and left as such for 24 hours. Thus solidified, the coating film was peeled from the polyimide film, and washed with water. After dried, the white film thus formed had a thickness of 110 μm. With a polarizing microscope, fine domains of optical anisotropy were confirmed in the film. From this, it is understood that the mesogen part of S-13 aggregated in a predetermined direction and its aggregates formed the film.

(5) Formation of Solid Electrolytic Membrane (E-2-5):

SO₃-DMF complex (from Aldrich) (0.18 g) was added to a solution of DMF (0.5 ml) with A-24 (0.1 g) dissolved therein, and reacted at room temperature for 12 hours. Next, S-13 (240 mg) and water (0.16 ml) were added to it, and stirred under heat at 50° C. for 3 hours. The resulting mixture was cast on a polyimide film (Upilex-75S by Ube Kosan), and left as such for 24 hours. Thus solidified, the coating film was peeled from the polyimide film, and washed with water. After dried, the white film thus formed had a thickness of 130 μm. With a polarizing microscope, fine domains of optical anisotropy were confirmed in the film. From this, it is understood that the mesogen part of S-13 aggregated in a predetermined direction and its aggregates formed the film.

(6) Formation of Solid Electrolytic Membrane (E-2-6):

SO₃-DMF complex (from Aldrich) (0.22 g) was added to a solution of DMF (0.5 ml) with A-29 (0.1 g) dissolved therein, and reacted at room temperature for 12 hours. Next, S-13 (150 mg) and water (0.10 ml) were added to it, and stirred under heat at 60° C. for 4 hours. The resulting mixture was cast on a polyimide film (Upilex-75S by Ube Kosan), and left as such for 24 hours. Thus solidified, the coating film was peeled from the polyimide film, and washed with water. After dried, the white film thus formed had a thickness of 120 μm. With a polarizing microscope, fine domains of optical anisotropy were confirmed in the film. From this, it is understood that the mesogen part of S-13 aggregated in a predetermined direction and its aggregates formed the film.

(7) Formation of Solid Electrolytic Membrane (E-2-7):

A-14 (0.1 g) and S-13 (207 mg) were dissolved in ethanol, and 50 μl of 2% hydrochloric acid was added to it at 25° C. and stirred for 20 minutes. The resulting mixture was cast on a polyimide film (Upilex-75S by Ube Kosan), and left as such for 72 hours. The polyimide film was dipped in DMF (0.5 ml) with SO₃-DMF complex (from Aldrich) (0.15 g) dissolved therein, and the coating film was peeled from the polyimide film and washed with water. After dried, the film thus formed had a thickness of 130 μm. With a polarizing microscope, fine domains of optical anisotropy were confirmed in the film. From this, it is understood that the mesogen part of S-13 aggregated in a predetermined direction and its aggregates formed the film.

(8) Formation of Solid Electrolytic Membrane (E-2-8):

SO₃-DMF complex (from Aldrich) (0.15 g) was added to a solution of DMF (0.5 ml) with A-14 (0.1 g) dissolved therein, and reacted at room temperature for 12 hours. Next, S-25 (200 mg) and water (0.11 ml) were added to it, and stirred under heat at 60° C. for 4 hours. The resulting mixture was cast on a polyimide film (Upilex-75S by Ube Kosan), and left as such for 24 hours. Thus solidified, the coating film was peeled from the polyimide film, and washed with water. After dried, the white film thus formed had a thickness of 120 μm. With a polarizing microscope, fine domains of optical anisotropy were confirmed in the film. From this, it is understood that the mesogen part of S-25 aggregated in a predetermined direction and its aggregates formed the film.

(9) Formation of Solid Electrolytic Membrane (E-2-9):

SO₃-DMF complex (from Aldrich) (0.0532 g), A-13 (0.0347 g) and S-30 (0.15 g) were dissolved in DMF (0.75 ml), and stirred at 25° C. for 7 hours (this solution is referred to as SOL-1). Water (0.06 ml) was added to SOL-1, and then cast on a Teflon sheet and left at 70° C. for 4 hours. Thus solidified, the coating film was peeled from the Teflon sheet, and washed with water. After dried, the white film thus formed had a thickness of 150 μm. With a polarizing microscope, fine domains of optical anisotropy were confirmed in the film. From this, it is understood that the mesogen part of S-30 aggregated in a predetermined direction and its aggregates formed the film.

(10) Formation of Solid Electrolytic Membrane (E-2-10):

SO₃-DMF complex (from Aldrich) (0.15 g) was added to a solution of DMF (0.5 ml) with A-14 (0.1 g) and S-13 (0.207 g) dissolved therein, and reacted at 80° C. for 4 hours. Next, water (0.11 ml) was added to it, and stirred under heat at 60° C. for 4 hours. The resulting mixture was cast on a polyimide film (Upilex-75S by Ube Kosan), and left as such for 24 hours. Thus solidified, the coating film was peeled from the polyimide film, and washed with water. After dried, the film thus formed had a thickness of 125 μm. With a polarizing microscope, fine domains of optical anisotropy were confirmed in the film. From this, it is understood that the mesogen part of S-13 aggregated in a predetermined direction and its aggregates formed the film.

(11) Formation of Solid Electrolytic Membrane (R-2-1):

IV-13 (800 mg) and TEOS (200 mg) were dissolved in ethanol, and 50 μl of 2% hydrochloric acid was added to it at 25° C. and stirred for 20 minutes. Phosphoric acid/isopropanol solution (phosphoric acid, H₃PO₄, 500 mg/isopropanol 1 ml) was added to the solution, and stirred at 25° C. for 30 minutes, and then this was applied to a Teflon sheet by the use of an applicator. This was left at room temperature for 2 hours, and then heated at 50° C. for 2 hours, and further at 80° C. for 3 hours. Next, this was peeled from the Teflon sheet, and a comparative transparent sheet solid (R-2-1) having a thickness of 85 μm was obtained.

### Example 1-3:

(1) Formation of Solid Electrolytic Membrane (E-3-1):

SO₃-DMF complex (from Aldrich) (0.93 g) was added to a solution of DMF (2.5 ml) with A-1 (0.50 g) dissolved therein, and reacted at room temperature for 12 hours. Next, water (80 μl) was added to it, and stirred under heat at 60° C. for 4 hours. The resulting mixture was cast on a Teflon sheet (Teflon®-the same shall apply hereinunder), and left as such for 72 hours. Thus solidified, the coating film was peeled from the Teflon sheet, and washed with water. After dried, the film thus formed had a thickness of 123 μm.

(2) Formation of Solid Electrolytic Membrane (E-3-2):

SO₃-DMF complex (from Aldrich) (0.48 g) was added to a solution of DMF (2.5 ml) with A-6 (0.50 g) dissolved therein, and reacted at room temperature for 12 hours. Next, water (56 μl) was added to it, and stirred under heat at 60° C. for 5 hours. The resulting mixture was cast on a Teflon sheet, and left as such for 72 hours. Thus solidified, the coating film was peeled from the Teflon sheet, and washed with water. After dried, the film thus formed had a thickness of 145 μm.

(3) Formation of Solid Electrolytic Membrane (E-3-3):

SO₃-DMF complex (from Aldrich) (0.93 g) was added to a solution of DMF (2.5 ml) with A-1 (0.5 g) dissolved therein, and reacted at room temperature for 12 hours. Next, IV-3 (20 mg) and water (78 μl) were added to it, and stirred under heat at 60° C. for 4 hours. The resulting mixture was cast on a Teflon sheet, and left as such for 72 hours. Thus solidified, the coating film was peeled from the Teflon sheet, and washed with water. After dried, the film thus formed had a thickness of 130 μm.

(4) Formation of Solid Electrolytic Membrane (E-3-4):

SO₃-DMF complex (from Aldrich) (0.68 g) was added to a solution of DMF (2.5 ml) with A-2 (0.5 g) dissolved therein, and reacted at room temperature for 12 hours. Next, IV-5 (28 mg) and water (61 μl) were added to it, and stirred under heat at 50° C. for 5 hours. The resulting mixture was cast on a Teflon sheet, and left as such for 72 hours. Thus solidified, the coating film was peeled from the Teflon sheet, and washed with water. After dried, the film thus formed had a thickness of 134 μm.

(5) Formation of Solid Electrolytic Membrane (E-3-5):

SO₃-DMF complex (from Aldrich) (0.48 g) was added to a solution of DMF (2.5 ml) with A-7 (0.5 g) dissolved therein, and reacted at room temperature for 12 hours. Next, IV-13 (12 mg) and water (59 μl) were added to it, and stirred under heat at 50° C. for 5 hours. The resulting mixture was cast on a Teflon sheet, and left as such for 72 hours. Thus solidified, the coating film was peeled from the Teflon sheet, and washed with water. After dried, the film thus formed had a thickness of 125 μm.

(6) Formation of Solid Electrolytic Membrane (E-3-6):

A-1 (0.5 g), IV-13 (16 mg) and TEOS (14 mg) were dissolved in ethanol, and 50 μl of 2% hydrochloric acid was added to it at 25° C. and stirred at room temperature for 3 hours. The resulting mixture was cast on a Teflon sheet, and left as such for 5 days. The film peeled from the Teflon sheet was dipped in DMF (2.5 ml) with SO₃-DMF complex (from Aldrich) (0.62 g) dissolved therein, and then washed with water. After dried, the film thus formed had a thickness of 130 μm.

(7) Formation of Solid Electrolytic Membrane (R-3-1):

A solution prepared by dissolving liquid SO₃ (80 mg) in 0.2 ml of methylene chloride was dropwise added to a methylene chloride (0.5 ml) solution of IV-3 (0.24 g). This was reacted at room temperature for 5 hours, and the solvent was evaporated away. An ethanol solution of IV-13 (0.24 g) and water were added to the resulting residue, and stirred at 60° C. for 4 hours. The resulting mixture was cast on a Teflon sheet, and left as such for 24 hours. Thus solidified, the coating film was peeled from the Teflon sheet and washed with water. After dried, the film thus formed had a thickness of 130 μm.

(8) Formation of Solid Electrolytic Membrane (R-3-2):

Based on the references described in Solid State Ionics, 2001, No. 145, p. 137, the following compound was produced, but it could not form a film.

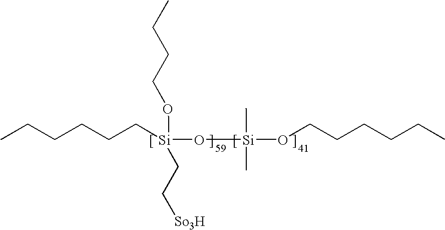

### Example 1-4:

(1) Formation of Solid Electrolytic Membrane (E-4-1):

SO₃-DMF complex (from Aldrich) (0.47 g) was added to a solution of DMF (1.2 ml) with A-1 (0.25 g) dissolved therein, and reacted at room temperature for 12 hours. Next, S-13 (0.41 g) and water (75 μl) were added to it, and stirred under heat at 60° C. for 4 hours. The resulting mixture was cast on a Teflon sheet, and left as such for 72 hours. Thus solidified, the coating film was peeled from the Teflon sheet, and washed with water. After dried, the film thus formed had a thickness of 123 μm. With a polarizing microscope, fine domains of optical anisotropy were confirmed in the film. From this, it is understood that the mesogen part of S-13 aggregated in a predetermined direction and its aggregates formed the film.

(2) Formation of Solid Electrolytic Membrane (E-4-2):

SO₃-DMF complex (from Aldrich) (0.24 g) was added to a solution of DMF (1.2 ml) with A-6 (0.25 g) dissolved therein, and reacted at room temperature for 12 hours. Next, S-13 (0.32 g) and water (56 μl) were added to it, and stirred under heat at 50° C. for 5 hours. The resulting mixture was cast on a Teflon sheet, and left as such for 72 hours. Thus solidified, the coating film was peeled from the Teflon sheet, and washed with water. After dried, the film thus formed had a thickness of 125 μm. With a polarizing microscope, fine domains of optical anisotropy were confirmed in the film. From this, it is understood that the mesogen part of S-13 aggregated in a predetermined direction and its aggregates formed the film.

(3) Formation of Solid Electrolytic Membrane (E-4-3):

SO₃-DMF complex (from Aldrich) (0.31 g) was added to a solution of DMF (1.2 ml) with A-1 (0.25 g) dissolved therein, and reacted at room temperature for 12 hours. Next, S-21 (0.40 g) and water (73 μl) were added to it, and stirred under heat at 60° C. for 4 hours (SOL-2). The resulting mixture was cast on a Teflon sheet, and left as such for 72 hours. Thus solidified, the coating film was peeled from the Teflon sheet, and washed with water. After dried, the film thus formed had a thickness of 132 μm. With a polarizing microscope, fine domains of optical anisotropy were confirmed in the film. From this, it is understood that the mesogen part of S-21 aggregated in a predetermined direction and its aggregates formed the film.

(4) Formation of Solid Electrolytic Membrane (E-4-4):

SO₃-DMF complex (from Aldrich) (0.31 g) was added to a solution of DMF (1.2 ml) with A-1 (0.25 g) and S-21 (0.40 g) dissolved therein, and reacted at room temperature for 12 hours. Next, water (73 μl) was added to it, and stirred under heat at 60° C. for 4 hours. The resulting mixture was cast on a Teflon sheet, and left as such for 72 hours. Thus solidified, the coating film was peeled from the Teflon sheet, and washed with water. After dried, the film thus formed had a thickness of 132 μm. With a polarizing microscope, fine domains of optical anisotropy were confirmed in the film. From this, it is understood that the mesogen part of S-21 aggregated in a predetermined direction and its aggregates formed the film.

(5) Formation of Solid Electrolytic Membrane (E-4-5):

SO₃-DMF complex (from Aldrich) (0.31 g) was added to a solution of DMF (1.2 ml) with A-1 (0.25 g) dissolved therein, and reacted at room temperature for 12 hours. Next, S-26 (0.50 g) and water (73 μl) were added to it, and stirred under heat at 60° C. for 4 hours. The resulting mixture was cast on a Teflon sheet, and left as such for 72 hours. Thus solidified, the coating film was peeled from the Teflon sheet, and washed with water. After dried, the film thus formed had a thickness of 140 μm. With a polarizing microscope, fine domains of optical anisotropy were confirmed in the film. From this, it is understood that the mesogen part of S-26 aggregated in a predetermined direction and its aggregates formed the film.

(6) Formation of Solid Electrolytic Membrane (E-4-6):

SO₃-DMF complex (from Aldrich) (0.31 g) was added to a solution of DMF (1.2 ml) with A-1 (0.25 g) dissolved therein, and reacted at room temperature for 12 hours. Next, S-30 (0.87 g) and water (73 μl) were added to it, and stirred under heat at 60° C. for 4 hours. The resulting mixture was cast on a Teflon sheet, and left as such for 72 hours. Thus solidified, the coating film was peeled from the Teflon sheet, and washed with water. After dried, the film thus formed had a thickness of 138 μm. With a polarizing microscope, fine domains of optical anisotropy were confirmed in the film. From this, it is understood that the mesogen part of S-30 aggregated in a predetermined direction and its aggregates formed the film.

(7) Formation of Solid Electrolytic Membrane (E-4-7):

A-1 (0.25 g) and S-21 (0.40 g) were dissolved in ethanol, and 125 μl of 2% hydrochloric acid was added to it at 25° C. and stirred for 20 minutes. The resulting mixture was cast on a Teflon sheet, and left as such for 72 hours. Thus solidified, the coating film was peeled from the Teflon sheet, and this was dipped in DMF (0.13 ml) with SO₃-DMF complex (from Aldrich) (0.31 g) dissolved therein, and then washed with water. After dried, the film thus formed had a thickness of 130 μm. With a polarizing microscope, fine domains of optical anisotropy were confirmed in the film. From this, it is understood that the mesogen part of S-21 aggregated in a predetermined direction and its aggregates formed the film.

(8) Formation of Solid Electrolytic Membrane (E-4-8):

SO₃-DMF complex (from Aldrich) (0.31 g) was added to a solution of DMF (1.2 ml) with A-1 (0.25 g) and S-21 (0.40 g) dissolved therein, and reacted at 80° C. for 4 hours. Next, water (73 μl) were added to it, and stirred under heat at 60° C. for 4 hours. The resulting mixture was cast on a Teflon sheet, and left as such for 72 hours. Thus solidified, the coating film was peeled from the Teflon sheet, and washed with water. After dried, the film thus formed had a thickness of 138 μm. With a polarizing microscope, fine domains of optical anisotropy were confirmed in the film. From this, it is understood that the mesogen part of S-21 aggregated in a predetermined direction and its aggregates formed the film.

(9) Formation of Solid Electrolytic Membrane (R-4-1):

IV-13 (800 mg) and TEOS (200 mg) weredissolvedinethanol, and 50 μl of 2% hydrochloric acid was added to it at 25° C. and stirred for 20 minutes. Phosphoric acid/isopropanol solution (prepared by dissolving phosphoric acid (H₃PO₄, 500 mg) in 1 ml of isopropanol) was added to the solution, and stirred at 25° C. for 30 minutes, and then this was applied to a Teflon sheet by the use of an applicator. This was left at room temperature for 2 hours, and then heated at 50° C. for 2 hours, and further at 80° C. for 3 hours. Next, this was peeled from the Teflon sheet, and a comparative transparent sheet solid (R-4-1) having a thickness of 85 μm was obtained.

### Example 2

### Resistance to Aqueous Methanol Solution:

Circular discs having a diameter of 13 mm were blanked out of the thus-obtained, solid electrolytic membranes (E-1-1 to E-1-10, E-2-1 to E-2-10, E-3-1 to E-3-6, E-4-1 to E-4-8) of the invention and comparative solid electrolytic membranes (R-1-1 to R-1-2, R-2-1, R-3-1, R-4-1) and Nafion 117 (from DuPont), and these samples were separately dipped in 5 ml of an aqueous 10 mas.% methanol solution for 48 hours. The solid electrolytic membranes (E-1-1 to E-1-10, E-2-1 to E-2-10, E-3-1 to E-3-6, E-4-1 to E-4-8) of the invention swelled little, and their shape and strength did not change from those of the non-dipped samples. However, the comparative samples, R-1-1 to R-1-2, R-2-1, R-3-1 and R-4-1 cracked. In addition, 85% by mass of phosphoric acid, relative to the theoretical amount thereof, dissolved in the aqueous methanol solution of R-1-1. Nafion 117 swelled by about 70% by mass, and its film shape changed. From the above, it is understood that the solid electrolytic membranes of the invention are sufficiently resistant to aqueous methanol solution that serves as fuel in direct methanol fuel cells.

### Example 3

### Determination of Methanol Perviousness:

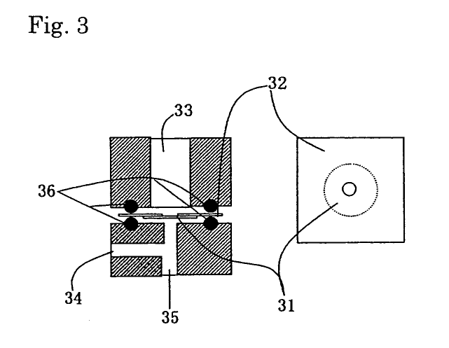

Circular discs having a diameter of 13 mm were blanked out of the thus-obtained, solid electrolytic membranes E-1-3, E-1-4, E-1-6, E-1-8, E-1-10, E-2-1 to E-2-10, E-3-1 to E-3-6, E-4-1 to E-4-8) of the invention and comparative solid electrolytic membranes (R-1-1, R-2-1, R-3-1, R-4-1) and Nafion 117, and these samples were reinforced with a Teflon tape having a circular hole (diameter, 5 mm) formed therein. The reinforced membrane was fitted to a stainless cell as in FIG. 3, and aqueous methanol solution was put into the upper space above the membrane, and a hydrogen gas was fed thereinto through a lower gas inlet mouth at a constant flow rate. The amount of methanol having passed through the membrane was determined with a gas chromatography device of which the detector was connected to the lower detection mouth for methanol. The results are given in Tables 1 to 4. The methanol concentration in these Tables is a relative value based on the standard amount (1) from Nafion 117. In FIG. 3, 31 is a solid electrolytic membrane; 32 is a reinforcing Teflon tape; 33 is a mouth for aqueous methanol introduction; 34 is a carrier gas inlet mouth; 35 is a detection mouth (connected to gas chromatography); 36 is a rubber gasket.

TABLE 1

| Solid Electrolyte | Methanol Concentration | | | |
|---|---|---|---|---|
| Membrane | 4.6 mas % | 18.6 mas % | 46 mas % | Remarks |
| R-1-1 | 0.30 | NG | NG | comparison |
| E-1-3 | 0.10 | 0.10 | 0.11 | the invention |
| E-1-4 | 0.12 | 0.13 | 0.15 | the invention |
| E-1-6 | 0.11 | 0.12 | 0.14 | the invention |
| E-1-8 | 0.14 | 0.15 | 0.20 | the invention |
| E-1-10 | 0.12 | 0.13 | 0.13 | the invention |

NG: Immeasurable as the membrane broke.

TABLE 2

| Solid Electrolyte | Methanol Concentration | | | |
|---|---|---|---|---|
| Membrane | 4.6 mas % | 18.6 mas % | 46 mas % | Remarks |
| R-2-1 | 0.30 | NG | NG | comparison |
| E-2-1 | 0.07 | 0.10 | 0.10 | the invention |
| E-2-2 | 0.07 | 0.09 | 0.10 | the invention |
| E-2-3 | 0.08 | 0.10 | 0.11 | the invention |
| E-2-4 | 0.06 | 0.07 | 0.07 | the invention |
| E-2-5 | 0.05 | 0.06 | 0.06 | the invention |
| E-2-6 | 0.08 | 0.08 | 0.10 | the invention |
| E-2-7 | 0.07 | 0.09 | 0.10 | the invention |
| E-2-8 | 0.02 | 0.02 | 0.02 | the invention |
| E-2-9 | 0.02 | 0.04 | 0.04 | the invention |
| E-2-10 | 0.08 | 0.10 | 0.11 | the invention |

NG: Immeasurable as the membrane broke.

TABLE 3

| Solid Electrolyte | Methanol Concentration | | | |
|---|---|---|---|---|
| Membrane | 4.6 mas % | 18.6 mas % | 46 mas % | Remarks |
| R-3-1 | 0.30 | NG | NG | comparison |
| E-3-1 | 0.13 | 0.14 | 0.16 | the invention |
| E-3-2 | 0.12 | 0.15 | 0.18 | the invention |
| E-3-3 | 0.12 | 0.13 | 0.15 | the invention |
| E-3-4 | 0.13 | 0.15 | 0.19 | the invention |
| E-3-5 | 0.14 | 0.16 | 0.19 | the invention |
| E-3-6 | 0.13 | 0.15 | 0.18 | the invention |

NG: Immeasurable as the membrane broke.

TABLE 4

| Solid Electrolyte | Methanol Concentration | | | |
|---|---|---|---|---|
| Membrane | 4.6 mas % | 18.6 mas % | 46 mas % | Remarks |
| R-4-1 | 0.30 | NG | NG | comparison |
| E-4-1 | 0.08 | 0.11 | 0.13 | the invention |
| E-4-2 | 0.09 | 0.11 | 0.12 | the invention |
| E-4-3 | 0.08 | 0.12 | 0.13 | the invention |
| E-4-4 | 0.07 | 0.09 | 0.12 | the invention |
| E-4-5 | 0.08 | 0.11 | 0.13 | the invention |
| E-4-6 | 0.09 | 0.12 | 0.14 | the invention |
| E-4-7 | 0.09 | 0.12 | 0.13 | the invention |
| E-4-8 | 0.09 | 0.12 | 0.14 | the invention |

NG: Immeasurable as the membrane broke.

Conclusion:

Table 1 confirms that the methanol perviousness of the first solid electrolytic membranes of the invention is smaller than ⅕ of that of Nafion 117 when the methanol concentration is, for example, 4.6% by mass. Table 2 confirms that the methanol perviousness of the solid electrolytic membranes of the invention that contain mesogen group-having organic molecular chains is smaller than 1/10 of that of Nafion 117 when the methanol concentration is, for example, 4.6% by mass.

Table 3 confirms that the methanol perviousness of the second solid electrolytic membranes of the invention is smaller than 1/7 of that of Nafion 117 when the methanol concentration is, for example, 4.6% by mass. Table 4 confirms that the methanol perviousness of the solid electrolytic membranes of the invention that contain mesogen group-having organic molecular chains is smaller than 1/11 of that of Nafion 117 when the methanol concentration is, for example, 4.6% by mass.

### Example 4

### Determination of Ionic Conductivity:

Circular discs having a diameter of 13 mm were blanked out of the thus-obtained in Example 1, solid electrolytic membranes (E-1-1 to E-1-10, E-2-1 to E-2-10, E-3-1 to E-3-6, E-4-1 to E-4-8) of the invention and comparative solid electrolytic membranes (R-1-1 to R-1-2, R-2-1, R-3-1, R-4-1) and Nafion 117. Sandwiched between two stainless plates, the ionic conductivity of each of these samples was measured at 25° C. and at a relative humidity of 95% according to an AC impedance process. The results are given in Tables 5 to 8.

TABLE 5

| | Ionic Conductivity | |
|---|---|---|
| Solid Electrolytic Membrane | ×10⁻³ S/cm | Remarks |
| E-1-1 | 0.37 | the invention |
| E-1-2 | 0.39 | the invention |
| E-1-3 | 0.40 | the invention |
| E-1-4 | 0.45 | the invention |
| E-1-5 | 0.38 | the invention |
| E-1-6 | 0.42 | the invention |
| E-1-7 | 0.44 | the invention |
| E-1-8 | 0.48 | the invention |
| E-1-9 | 0.41 | the invention |
| E-1-10 | 0.42 | the invention |
| R-1-1 | 0.12 | comparison |
| R-1-2 | 0.27 | comparison |
| Nafion 117 | 6.7 | comparison |

TABLE 6

| | Ionic Conductivity | |
|---|---|---|
| Solid Electrolytic Membrane | ×10⁻³ S/cm | Remarks |
| E-2-1 | 0.55 | the invention |
| E-2-2 | 0.54 | the invention |
| E-2-3 | 0.49 | the invention |
| E-2-4 | 0.52 | the invention |
| E-2-5 | 0.51 | the invention |
| E-2-6 | 0.52 | the invention |
| E-2-7 | 0.53 | the invention |
| E-2-8 | 0.58 | the invention |
| E-2-9 | 0.63 | the invention |
| E-2-10 | 0.78 | the invention |
| R-2-1 | 0.12 | comparison |
| Nafion 117 | 6.7 | comparison |

TABLE 7

| | Ionic Conductivity | |
|---|---|---|
| Solid Electrolytic Membrane | ×10⁻³ S/cm | Remarks |
| E-3-1 | 0.52 | the invention |
| E-3-2 | 0.55 | the invention |
| E-3-3 | 0.51 | the invention |
| E-3-4 | 0.56 | the invention |
| E-3-5 | 0.56 | the invention |
| E-3-6 | 0.57 | the invention |
| R-3-1 | 0.27 | comparison |
| Nafion 117 | 6.7 | comparison |

TABLE 8

| | Ionic Conductivity | |
|---|---|---|
| Solid Electrolytic Membrane | ×10⁻³ S/cm | Remarks |
| E-4-1 | 0.72 | the invention |
| E-4-2 | 0.76 | the invention |
| E-4-3 | 0.77 | the invention |
| E-4-4 | 0.77 | the invention |
| E-4-5 | 0.72 | the invention |
| E-4-6 | 0.73 | the invention |
| E-4-7 | 0.74 | the invention |
| E-4-8 | 0.86 | the invention |
| R-4-1 | 0.12 | comparison |
| Nafion 117 | 6.7 | comparison |

Conclusion:

Though not comparable to Nafion 117, it is understood that the solid electrolytic membranes of the invention have a higher ionic conductivity than the comparative solid electrolytic membranes (R-1-1 to R-1-2, R-2-1, R-3-1, R-4-1).

### Example 5

### Formation of Catalyst Membrane:

(1-1) Formation of Catalyst Membrane A:

2 g of platinum-carrying carbon (Vulcan XC72 with 50 mas.% platinum) was mixed with 15 g of a Nafion solution (5% alcoholic aqueous solution), and dispersed for 30 minutes with an ultrasonic disperser. The mean particle size of the resulting dispersion was about 500 nm. The dispersion was applied onto carbon paper (having a thickness of 350 μm) and dried, and a circular disc having a diameter of 9 mm was blanked out of it. This is catalyst membrane A.

(1-2) Formation of Catalyst Membrane B:

SOL-1 (0.8 ml) prepared in Example 1 was added to 300 mg of platinum/ruthenium-carrying carbon (20 mas.% platinum and 20 mas.% ruthenium were held on ketjen black) that had been wetted with 0.3 ml of water, and then dispersed for 10 minutes with an ultrasonic disperser. The resulting paste was applied onto carbon paper (having a thickness of 350 μm) and dried, and a circular disc having a diameter of 9 mm was blanked out of it. This is catalyst membrane B.

(1-3) Formation of Catalyst Membrane C:

Catalyst membrane C was produced in the same manner as in (1-2) except that the platinum-carrying carbon as in (1-1) is used in place of the platinum/ruthenium-carrying carbon.

(1-4) Formation of Catalyst Membrane D:

Catalyst membrane D was produced in the same manner as in (1-2) except that SOL-2 above is used in place of SOL-1.

(1-5) Formation of Catalyst Membrane E:

Catalyst membrane E was produced in the same manner as in (1-4) except that the platinum-carrying carbon as in (1-1) is used in place of the platinum/ruthenium-carrying carbon.

(2) Fabrication of MEA:

The catalyst membrane A prepared in the above was attached to both surfaces of the solid electrolytic membrane (E-1-3, E-1-4, E-1-6, E-1-7, E-1-8, E-2-1, E-2-4, E-2-6, E-2-8, E-2-9, E-3-1, E-3-2, E-3-4, E-3-5, E-3-6, E-4-2, E-4-3, E-4-4, E-4-6, E-4-7) formed in Example 1 and Nafion 117 in such a manner that the coated face of the catalyst membrane A could be contacted with the solid electrolytic membrane, and hot-pressed at 80° C. under 3 MPa for 2 minutes to fabricate MEA-1-1 to MEA-1-5, MEA-2-1 to MEA-2-5, MEA-3-1, MEA-3-2, MEA-3-4 to MEA-3-6, MEA-4-2, MEA-4-3a, MEA-4-4, MEA-4-6, MEA-4-7 and MEA-6. On the other hand, the catalyst membrane B was attached to one face of the solid electrolytic membrane E-2-9 and Nafion 117, while the catalyst membrane C was to the other face thereof, and the catalyst membrane D was attached to one face of the solid electrolytic membrane E-4-3 and Nafion 117, while the catalyst membrane E was to the other face thereof. These were hot-pressed at 80° C. under 1 MPa for 1 minute to fabricate MEA-2-7, MEA-2-R2, MEA-4-3b, MEA-4-R2.

(3) Fuel Cell Properties:

The MEA fabricated in (2) was set in a fuel cell as in FIG. 2, and an aqueous 46 mas.% methanol solution was fed into the cell via the anode-side opening 15. MEA-2-7, MEA-2-R2, MEA-4-R2 and MEA-4-3b were so set that the catalyst membrane B or D could be on the anode side and the catalyst membrane C or E could be on the cathode side. In this condition, the cathode-side opening 16 was kept open to air. Using a galvanostat, a constant current of 5 mA/cm² was applied between the anode 12 and the cathode 13, and the cell voltage was measured in this stage. The results are given in Tables 9 to 12.

TABLE 9

| | | | Time-Dependent Change | | | |
|---|---|---|---|---|---|---|
| Solid | | | of Terminal Voltage (V) | | | |
| Electrolyte | | | | after | after | |
| Membrane | MEA | Cell C | initial | 0.5 hrs | 1 hr | Remarks |
| E-1-3 | 1-1 | 1-1 | 0.57 | 0.55 | 0.54 | the invention |
| E-1-4 | 1-2 | 1-2 | 0.61 | 0.57 | 0.56 | the invention |
| E-1-6 | 1-3 | 1-3 | 0.59 | 0.58 | 0.55 | the invention |
| E-1-7 | 1-4 | 1-4 | 0.60 | 0.58 | 0.57 | the invention |
| E-1-8 | 1-5 | 1-5 | 0.62 | 0.59 | 0.57 | the invention |
| Nafion 117 | 6 | 6 | 0.68 | 0.44 | 0.38 | comparison |

TABLE 10

| | | | Time-Dependent Change | | | |
|---|---|---|---|---|---|---|
| Solid | | | of Terminal Voltage (V) | | | |
| Electrolyte | | | | after | after | |
| Membrane | MEA | Cell C | initial | 0.5 hrs | 1 hr | Remarks |
| E-2-1 | 2-1 | 2-1 | 0.62 | 0.57 | 0.55 | the invention |
| E-2-4 | 2-2 | 2-2 | 0.60 | 0.56 | 0.56 | the invention |
| E-2-6 | 2-3 | 2-3 | 0.59 | 0.56 | 0.54 | the invention |
| E-2-8 | 2-4 | 2-4 | 0.66 | 0.62 | 0.59 | the invention |
| E-2-9 | 2-5 | 2-5 | 0.68 | 0.64 | 0.61 | the invention |
| Nafion 117 | 6 | 6 | 0.68 | 0.44 | 0.38 | comparison |
| E-2-9 | 2-7 | 2-7 | 0.72 | 0.70 | 0.68 | the invention |
| Nafion 117 | 2-R2 | 2-R2 | 0.69 | 0.44 | 0.38 | comparison |

TABLE 11

| | | | Time-Dependent Change | | | |
|---|---|---|---|---|---|---|
| Solid | | | of Terminal Voltage (V) | | | |
| Electrolyte | | | | after | after | |
| Membrane | MEA | Cell C | initial | 0.5 hrs | 1 hr | Remarks |
| E-3-1 | 3-1 | 3-1 | 0.62 | 0.60 | 0.58 | the invention |
| E-3-2 | 3-2 | 3-2 | 0.61 | 0.58 | 0.57 | the invention |
| E-3-4 | 3-4 | 3-3 | 0.63 | 0.57 | 0.56 | the invention |
| E-3-5 | 3-5 | 3-4 | 0.62 | 0.60 | 0.58 | the invention |
| E-3-6 | 3-6 | 3-5 | 0.62 | 0.59 | 0.58 | the invention |
| Nafion 117 | 6 | 6 | 0.68 | 0.44 | 0.38 | comparison |

TABLE 12

| | | | Time-Dependent Change | | | |
|---|---|---|---|---|---|---|
| Solid | | | of Terminal Voltage (V) | | | |
| Electrolyte | | | | after | after | |
| Membrane | MEA | Cell C | initial | 0.5 hrs | 1 hr | Remarks |
| E-4-2 | 4-2 | 4-2 | 0.64 | 0.62 | 0.60 | the invention |
| E-4-3 | 4-3a | 4-3a | 0.64 | 0.62 | 0.61 | the invention |
| E-4-4 | 4-4 | 4-4 | 0.66 | 0.64 | 0.65 | the invention |
| E-4-6 | 4-6 | 4-6 | 0.65 | 0.64 | 0.62 | the invention |
| E-4-7 | 4-7 | 4-7 | 0.67 | 0.66 | 0.64 | the invention |
| Nafion 117 | 6 | 6 | 0.68 | 0.44 | 0.38 | comparison |
| E-4-3 | 4-3b | 4-3b | 0.73 | 0.71 | 0.69 | the invention |
| Nafion 117 | 4-R2 | 4-R2 | 0.67 | 0.42 | 0.37 | comparison |

The initial voltage of the cells C-6, C-2-R2 and C-4-R2, which comprise MEA-6, MEA-2-R2 and MEA-4-R2, respectively, with Nafion membrane, were high, but the voltage thereof lowered with time. The time-dependent voltage depression in the cell is caused by methanol crossover therein, or that is, the fuel methanol fed to the anode penetrates through the Nafion membrane to reach the cathode. As opposed to this, it is understood that the voltage of the cells C-1-1 to C-1-5, C-2-1 to C-2-5, C-2-7, C-3-1 to C-3-5, C-4-2, C-4-3a, C-4-3b, C-4-4, C-4-6 and C-4-7 of the invention, comprising MEA-1-1 to MEA-1-5, MEA-2-1 to MEA-2-5, MEA-3-1, MEA-3-2, MEA-3-4 to MEA-3-6, MEA-4-2, MEA-4-3a, MEA-4-4, MEA-4-6 and MEA-4-7 with the solid electrolytic membrane of the invention, was stable and the cells all had a higher voltage. In particular, it is understood that the cells C-2-7 and C-4-3b in which the solid electrolytic membrane is the same type as that in the catalyst membrane are especially excellent.

In the solid electrolytic membrane of the invention, the sulfo group is covalent-bonded to the silicon/oxygen three-dimensional crosslinked matrix, and therefore the membrane has a high ionic conductivity at room temperature. In addition, the resistance to aqueous methanol of the membrane is high, and the membrane is free from a trouble of methanol crossover through it. Accordingly, when the membrane is used in direct methanol fuel cells, then it enables higher output as compared with conventional solid electrolytic membranes. In addition, when at least apart of the organic molecular chains in the membrane are oriented to form aggregates therein, then the ionic conductivity of the membrane is further higher and the resistance to aqueous methanol of the membrane is also further higher. The membrane of the type is therefore especially excellent in that methanol crossover through it is further reduced and the membrane is free from a trouble of voltage depression.

The present disclosure relates to the subject matter contained in Japanese Patent Application No. 359927/2003 filed on Oct. 20, 2003 and Japanese Patent Application No. 025055/2004 filed on Feb. 2, 2004, which are expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A compound obtained according to a method comprising sulfonation of at least one compound of the following general formulae (I), (III) and (IV) followed by sol-gel reaction of the resulting compound, or according to a method comprising the sol-gel reaction followed by the sulfonation: 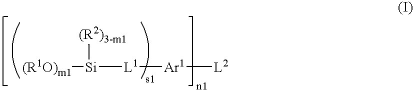
wherein R¹ represents a hydrogen atom, an alkyl group, an aryl group or a silyl group; R² represents an alkyl group, an aryl group or a heterocyclic group; m1 indicates an integer of from 1 to 3; L¹ represents a single bond, an alkylene group, —O—, —CO—, or a divalent linking group of a combination of any of these groups; L² represents an n1-valent linking group; Ar¹ represents an arylene or heteroarylene group having at least one electron-donating group; n1 indicates an integer of from 2 to 4; s1 indicates an integer of 1 or 2; 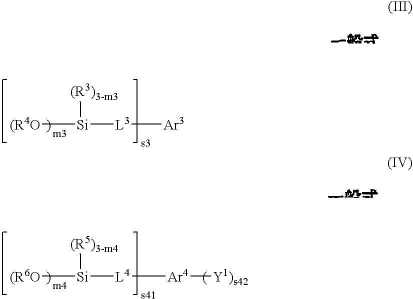
wherein R³ and R⁵ each represent an alkyl group, an aryl group or a heterocyclic group; R⁴ and R⁶ each represent a hydrogen atom, an alkyl group, an aryl group or a silyl group; m3 and m4 each indicate an integer of from 1 to 3; L³ and L⁴ each represent a single bond or a divalent linking group; Ar³ and Ar⁴ each represent an aryl or heteroaryl group or an arylene or heteroarylene group having at least one electron-donating group; s3, s41 and s42 each indicate an integer of from 1 to 4; Y¹ represents a polymerizing group capable of forming a carbon-carbon bond or a carbon-oxygen bond through polymerization.

2. The compound as claimed in claim 1, wherein at least one compound of formulae (I), (III) and (IV) is a compound of formula (I).

3. The compound as claimed in claim 1, wherein at least one compound of formulae (I), (III) and (IV) is at least one compound of formulae (III) and (IV).

4. The compound as claimed in claim 1, wherein at least one compound of formulae (I), (III) and (IV) is a compound of formula (I), and the compound of formula (I) contains n1 and the same partial structures of the following general formula (V): 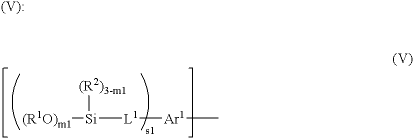
wherein R¹, R², m1, L¹, s1 and Ar¹ have the same meanings as those of R¹, R², m1, L¹, s1 and Ar¹ in formula (I).

5. The compound as claimed in claim 1, wherein at least one compound of formulae (I), (III) and (IV) is a compound of formula (I), and the compound of formula (I) is a compound of the following general formula (VI): 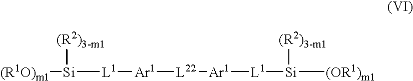
wherein R¹, R², m1, L¹ and Ar¹ have the same meanings as those of R¹, R², m1, L¹ and Ar¹ in formula (I); and L²² represents a divalent linking group.

6. The compound as claimed in claim 1, wherein the electron-donating group is a hydroxyl group or an alkoxy group.

7. The compound as claimed in claim 1, wherein the electron-donating group is a hydroxyl group.

8. The compound as claimed in claim 1, wherein at least one organosilicon compound having a mesogen-containing group is added to the sol-gel reaction.

9. The compound as claimed in claim 1, wherein at least one compound of the following general formulae (VII) and (VIII) is added to the sol-gel reaction: 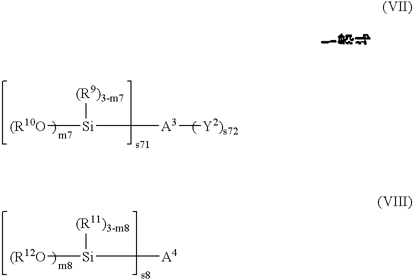
wherein A³ and A⁴ each represent a mesogen-containing organic atomic group; R⁹ and R¹¹ each represent an alkyl group, an aryl group or a heterocyclic group; R¹⁰ and R¹² each represent a hydrogen atom, an alkyl group, an aryl group or a silyl group; Y² represents a polymerizing group capable of forming a carbon-carbon bond or a carbon-oxygen bond through polymerization; m7 and m8 each indicate an integer of from 1 to 3; s71 and s8 each indicate an integer of from 1 to 8; s72 indicates an integer of from 1 to 4.

10. A solid electrolyte containing the compound of claim 1.

11. A proton conductor containing the compound of claim 1.

12. A membrane electrode assembly that contains a solid electrolytic membrane containing the compound of claim 1, between an anode and a cathode.

13. A membrane electrode assembly that contains a solid electrolytic membrane containing the compound of claim 1, in an anode and a cathode.

14. A fuel cell that contains a membrane electrode assembly with a solid electrolytic membrane containing the compound of claim 1, between an anode and a cathode.

15. A method for producing a solid electrolyte, which comprises sulfonation of at least one compound of the following general formula (I), (III) and (IV) followed by sol-gel reaction of the resulting compound, or comprises the sol-gel reaction followed by the sulfonation: 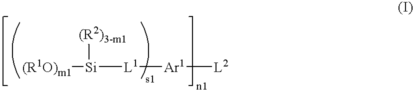
wherein R¹ represents a hydrogen atom, an alkyl group, an aryl group or a silyl group; R² represents an alkyl group, an aryl group or a heterocyclic group; m1 indicates an integer of from 1 to 3; L¹ represents a single bond, an alkylene group, —O—, —CO—, or a divalent linking group of a combination of any of these groups; L² represents an n1-valent linking group; Ar¹ represents an arylene or heteroarylene group having at least one electron-donating group; n1 indicates an integer of from 2 to 4; s1 indicates an integer of 1 or 2; 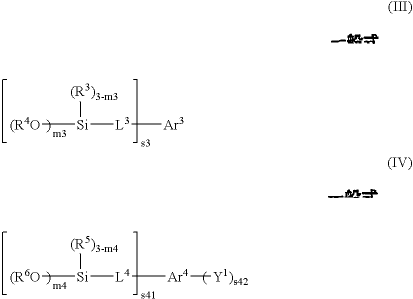
wherein R³ and R⁵ each represent an alkyl group, an aryl group or a heterocyclic group; R⁴ and R⁶ each represent a hydrogen atom, an alkyl group, an aryl group or a silyl group; m3 and m4 each indicate an integer of from 1 to 3; L³ and L⁴ each represent a single bond or a divalent linking group; Ar³ and Ar⁴ each represent an aryl or heteroaryl group or an arylene or heteroarylene group having at least one electron-donating group; s3, s41 and s42 each indicate an integer of from 1 to 4; Y¹ represents a polymerizing group capable of forming a carbon-carbon bond or a carbon-oxygen bond through polymerization.

16. The method for producing a solid electrolyte as claimed in claim 15, wherein the sulfonation is effected with SO₃ or an SO₃-organic complex.

17. The method for producing a solid electrolyte as claimed in claim 15, wherein the sulfonation temperature falls between 20° C. and 100° C.

18. The method for producing a solid electrolyte as claimed in claim 15, wherein the compound of formula (I) contains n1 and the same partial structures of the following general formula (V): 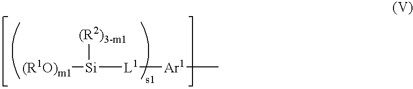
wherein R¹, R², m1, L¹, s1 and Ar¹ have the same meanings as those of R¹, R², m1, L¹, s1 and Ar¹ in formula (I).

19. The method for producing a solid electrolyte as claimed in claim 15, wherein the compound of formula (I) is a compound of the following general formula (VI): 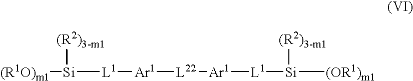
wherein R¹, R², m1, L¹ and Ar¹ have the same meanings as those of R¹, R², m1, L¹ and Ar¹ in formula (I); and L²² represents a divalent linking group.

20. The method for producing a solid electrolyte as claimed in claim 15, wherein the electron-donating group is a hydroxyl group or an alkoxy group.

21. The method for producing a solid electrolyte as claimed in claim 15, wherein the electron-donating group is a hydroxyl group.

22. The method for producing a solid electrolyte as claimed in claim 15, wherein at least one organosilicon compound having a mesogen-containing group is added to the sol-gel reaction.

23. The method for producing a solid electrolyte as claimed in claim 15, wherein at least one compound of the following general formulae (VII) and (VIII) is added to the sol-gel reaction: 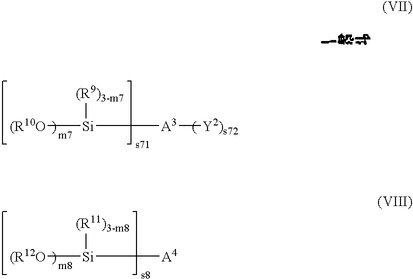
wherein A³ and A⁴ each represent a mesogen-containing organic atomic group; R⁹ and R¹¹ each represent an alkyl group, an aryl group or a heterocyclic group; R¹⁰ and R¹² each represent a hydrogen atom, an alkyl group, an aryl group or a silyl group; Y² represents a polymerizing group capable of forming a carbon-carbon bond or a carbon-oxygen bond through polymerization; m7 and m8 each indicate an integer of from 1 to 3; s71 and s8 each indicate an integer of from 1 to 8; s72 indicates an integer of from 1 to 4.
